(19) United States
(12) Patent Application Publication
(10) Pub. No.: US 2017/0060616 A1
(43) Pub. Date: Mar. 2, 2017

(54) MIGRATION CONTROLLING METHOD AND MIGRATION CONTROLLER

(71) Applicant: FUJITSU LIMITED, Kawasaki-shi (JP)

(72) Inventor: Koichi Onoue, Kawasaki (JP)

(73) Assignee: FUJITSU LIMITED, Kawasaki-shi (JP)

(21) Appl. No.: 15/245,225

(22) Filed: Aug. 24, 2016

(30) Foreign Application Priority Data
Sep. 1, 2015 (JP) 2015-172095

(51) Int. Cl. G06F 9/455

(52) U.S. Cl. CPC G06F 9/45558; G06F 2009/4557

(57) ABSTRACT

A migration controlling method includes reading state information indicating stats of virtual machines and physical machines, reading migration information corresponding to information of virtual machines, physical machine of migration source, and physical machine of migration destination, instructing migration of a first virtual machine to the second physical machine designated on the basis of the state information and migration information, instructing migration of a second virtual machine not instructed to migrate to the second physical machine to a third physical machine except of the second physical machine, and updating the state information on the basis of the state of the plurality of virtual machines and the plurality of physical machines after migration of the first and second virtual machines.

### CROSS-REFERENCE TO RELATED APPLICATION

This application is based upon and claims the benefit of priority of the prior Japanese Patent Application No. 2015-172095, filed on Sep. 1, 2015, the entire contents of which are incorporated herein by reference.

### FIELD

The present embodiment relates to a migration controlling method and a migration controller.

### BACKGROUND

In recent years, together with improvement in performance of physical machines, study of virtualization technologies for consolidating a plurality of virtual machines (VMs) into a single physical machine has been proceeding. According to the virtualization technologies, for example, virtualization software (hereinafter referred to also as hypervisor) allocates a physical machine to a plurality of virtual machines to make it possible to provide services by an application program (hereinafter referred to also as application) installed in each virtual machine.

In such virtual machines as described above, a manager who manages the virtual machines (hereinafter referred to simply as manager) performs migration of a virtual machine between a plurality of physical machines as occasion demands. Consequently, the manager can perform relocation of virtual machines in response to a use situation of a service by a user. Therefore, the manager can implement efficient use and so forth of physical resources of physical machines.

As examples of the prior art, Japanese Laid-open Patent Publication No. 2015-011569, Japanese Laid-open Patent Publication No. 2011-192049 and Japanese Laid-open Patent Publication No. 2013-239095 are known.

When such migration of a virtual machine as described above is to be performed, the manager would perform migration of a virtual machine to a physical machine that includes a residual physical resource from among physical machines in which virtual machines operate. However, in this case, a physical machine that can be a migration destination of a virtual machine is limited to a physical machine that currently includes a residual physical resource. Therefore, placement of virtual machines after migration of a virtual machine is performed may not be optimum placement of the virtual machines from the point of view of efficient use of physical resources of physical machines.

Besides, the manager can determine placement of virtual machines by which physical resources of physical machines can be used most efficiently (such placement is hereinafter referred to also as optimum placement) in advance by using of the mathematical planning such as, for example, optimization solver. However, the placement of virtual machines calculated by the mathematical planning does not take the situation of residual physical resources of physical machines during migration of the virtual machines into consideration. Therefore, it is sometimes difficult for the manager to specify an order of migration of virtual machines for relocating the virtual machines to optimum placement.

### SUMMARY

According to an aspect of the embodiment, a migration controlling method executed by a computer including a processor and a storage, includes reading state information indicating stats of a plurality of virtual machines and stats of a plurality of physical machines, the state information stored in the storage, reading migration information corresponding to information of the plurality of virtual machines, information of a first physical machine of migration source of the virtual machines, and information of a second physical machine of migration destination of the virtual machines, the first and second physical machines included in the plurality of physical machines, the migration information stored in the storage, instructing by the processor, migration of a first virtual machine to the second physical machine designated on the basis of the state information and migration information, instructing by the processor, migration of a second virtual machine not instructed to migrate to the second physical machine to a third physical machine except of the second physical machine, and updating by the processor, the state information on the basis of the state of the plurality of virtual machines and the plurality of physical machines after migration of the first and second virtual machines.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting a general configuration of an information processing system;

FIG. 2 is a view illustrating an example of virtual machines deployed in physical machines;

FIG. 3 is a view illustrating an example of virtual machines deployed in physical machines;

FIG. 4 is a view depicting a hardware configuration of an information processing apparatus;

FIG. 5 is a functional block diagram of the information processing apparatus of FIG. 4;

FIG. 6 is a flow chart illustrating an outline of a migration controlling process according to a first embodiment;

FIG. 7 is a flow chart illustrating details of the migration controlling process in the first embodiment;

FIG. 8 is a flow chart illustrating details of the migration controlling process in the first embodiment;

FIG. 9 is a flow chart illustrating details of the migration controlling process in the first embodiment;

FIG. 10 is a flow chart illustrating details of the migration controlling process in the first embodiment;

FIG. 11 is a flow chart illustrating details of the migration controlling process in the first embodiment;

FIG. 12 is a view illustrating an example of migration target information;

FIG. 13 is a view illustrating an example of physical machine state information;

FIG. 14 is a view illustrating an example of virtual machine state information;

FIG. 15 is a view illustrating an example of residual physical resource information;

FIG. 16 is a view illustrating an example of a migration virtual machine determination process executed for the first time;

FIG. 17 is a view illustrating an example of the migration virtual machine determination process executed for the first time;

FIG. 18 is a view illustrating an example of the migration virtual machine determination process executed for the first time;

FIG. 19 is a view illustrating an example of the migration virtual machine determination process executed for the first time;

FIG. 20 is a view illustrating an example of the migration virtual machine determination process executed for the first time;

FIG. 21 is a view illustrating an example of a retraction virtual machine determination process executed for the first time;

FIG. 22 is a view illustrating an example of the retraction virtual machine determination process executed for the first time;

FIG. 23 is a view illustrating an example of the retraction virtual machine determination process executed for the first time;

FIG. 24 is a view illustrating an example of the retraction virtual machine determination process executed for the first time;

FIG. 25 is a view illustrating an example of the retraction virtual machine determination process executed for the first time;

FIG. 26 is a view illustrating an example of the retraction virtual machine determination process executed for the first time;

FIG. 27 is a view illustrating an example of a virtual machine migration process executed for the first time;

FIG. 28 is a view illustrating an example of the virtual machine migration process executed for the first time;

FIG. 29 is a view illustrating an example of the migration virtual machine determination process executed for the second time;

FIG. 30 is a view illustrating an example of the migration virtual machine determination process executed for the second time;

FIG. 31 is a view illustrating an example of the migration virtual machine determination process executed for the second time;

FIG. 32 is a view illustrating an example of the virtual machine migration process executed for the second time;

FIG. 33 is a view illustrating an example of the virtual machine migration process executed for the second time;

FIG. 34 is a view illustrating an example of the migration virtual machine determination process executed for the third time;

FIG. 35 is a view illustrating an example of the migration virtual machine determination process executed for the third time;

FIG. 36 is a flow chart illustrating details of a migration controlling process according to a second embodiment;

FIG. 37 is a flow chart illustrating details of a migration controlling process according to a third embodiment;

FIG. 38 is a flow chart illustrating details of the migration controlling process according to the third embodiment;

FIG. 39 is a flow chart illustrating details of the migration controlling process according to the third embodiment;

FIG. 40 depicts an example of partial dependency graphs;

FIG. 41 depicts an example of a dependency graph;

FIG. 42 is a view illustrating an example of dependency virtual machine information;

FIG. 43 is a view illustrating an example of dependency virtual machine group information;

FIG. 44 is a view illustrating an example of a retraction virtual machine determination process and a virtual machine migration process executed for the first time;

FIG. 45 is a view illustrating an example of the retraction virtual machine determination process and the virtual machine migration process executed for the first time;

FIG. 46 is a view illustrating an example of the retraction virtual machine determination process and the virtual machine migration process executed for the first time;

FIG. 47 is a view illustrating an example of the retraction virtual machine determination process and the virtual machine migration process executed for the first time;

FIG. 48 is a view illustrating an example of a dependency virtual machine group determination process executed for the second time;

FIG. 49 is a view illustrating an example of the dependency virtual machine group determination process executed for the second time;

FIG. 50 is a view illustrating an example of the dependency virtual machine group determination process executed for the second time;

FIG. 51 is a view illustrating an example of the dependency virtual machine group determination process executed for the third time;

FIG. 52 is a view illustrating an example of the dependency virtual machine group determination process executed for the third time;

FIG. 53 is a view illustrating an example where a plurality of combinations of virtual machines that can be specified as dependency virtual machines exist;

FIG. 54 is a view illustrating an example where a plurality of combinations of virtual machines that can be specified as dependency virtual machines exist; and

FIG. 55 is a view illustrating an example where a plurality of combinations of specific virtual machines that can be specified as dependency virtual machines exist.

### DESCRIPTION OF EMBODIMENTS

In one aspect of the embodiments, it is desirable to provide a migration controlling program, a migration controlling apparatus and a migration controlling method for determining an order of migration of virtual machines involved in relocation of the virtual machines.

[Configuration of Information Processing System]

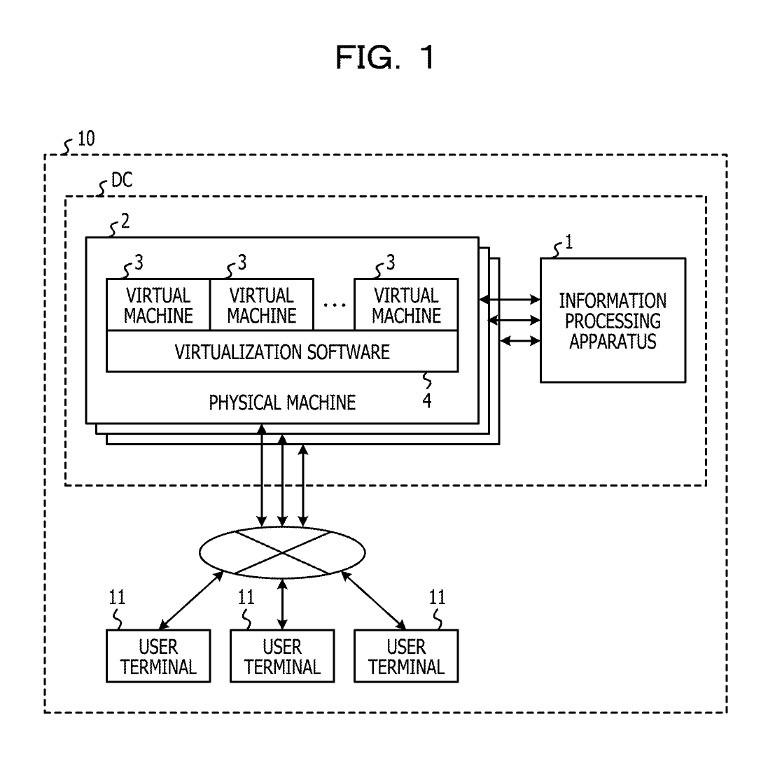

FIG. 1 is a view depicting a general configuration of an information processing system. An information processing system 10 depicted in FIG. 1 is, for example, a business system for providing a service to a user. The information processing system 10 depicted in FIG. 1 includes an information processing apparatus 1 and physical machines 2 provided in a data center DC. User terminals 11 can access the data center DC through a network such as the Internet or an intranet.

Each physical machine 2 is configured, for example, from a plurality of physical machines. Each physical machine includes a central processing unit (CPU), a memory (dynamic random access memory: DRAM), and a large-capacity memory such as a hard disk drive (HDD). Physical resources of the physical machine 2 are allocated to a plurality of virtual machines 3.

The information processing apparatus 1 can access the virtual machines 3 and manages the virtual machines 3 created in the physical machines 2. The information processing apparatus 1 may be created, for example, by a virtual machine 3.

Each virtual machine 3 provides an infrastructure thereof to a user through the network (hereinafter referred to as cloud service).

The cloud service is a service for providing a foundation for constructing and operating a computer system, namely, an infrastructure such as a virtual machine 3 or a network, through a network. Further, the user would select specifications for a virtual machine 3, for example, a clock frequency of a CPU, a capacity of a memory, a capacity of a hard disk and a communication bandwidth of a network and conclude a cloud use agreement regarding the selected matters. Further, the user would make it possible to perform operations for monitoring an operation state of the virtual machine 3, an operation for the virtual machine 3 and so forth, for example, through a user terminal 11.

Virtualization software 4 is foundation software for allocating the CPU, memory, hard disk and network of the physical machine 2 in accordance with an instruction from the information processing apparatus 1 to allow the virtual machine 3 to operate. The virtualization software 4 operates, for example, on the physical machine 2.

[Example of Virtual Machine Deployed in Physical Machine]

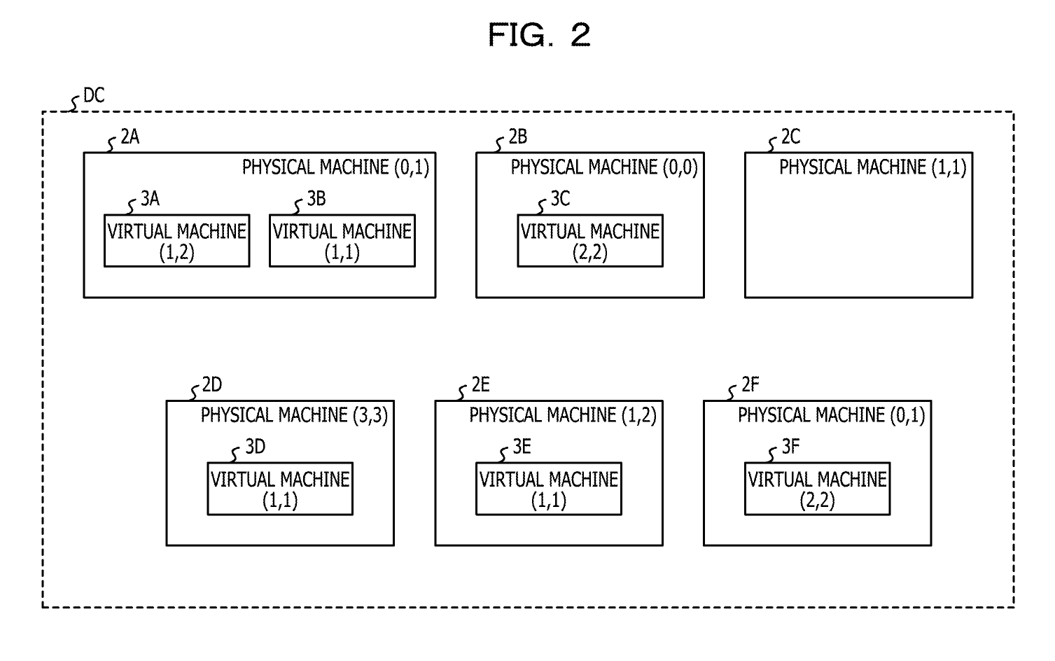

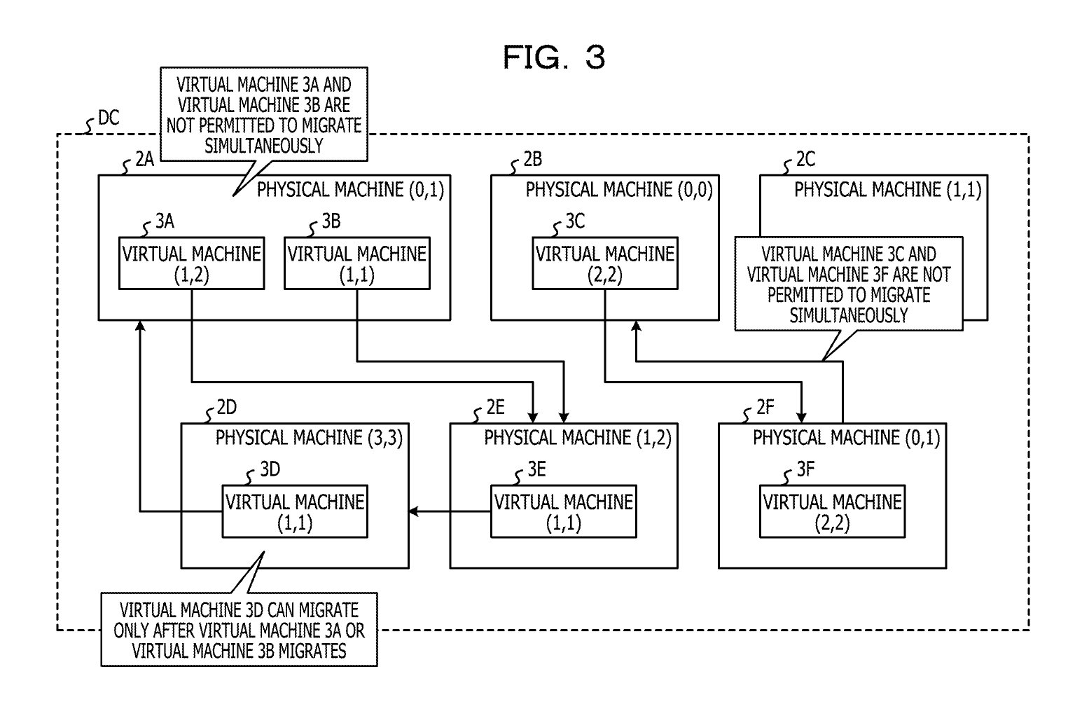

Now, an example of a virtual machine 3 deployed in a physical machine 2 is described. FIGS. 2 and 3 are views illustrating an example of a virtual machine 3 deployed in a physical machine 2.

In the example depicted in FIG. 2, physical machines 2A, 2B, 2C, 2D, 2E and 2F are deployed in the data center DC. Further, a virtual machine 3A and another virtual machine 3B are deployed in the physical machine 2A, and a virtual machine 3C is deployed in the physical machine 2B. Further, virtual machines 3D, 3E and 3F are deployed in the physical machines 2D, 2E and 2F, respectively.

It is to be noted that, in the example depicted in FIG. 2, “physical machine (0, 1)” in the physical machine 2A represents that the free space of the memory of the physical machine 2A is “0 (GB)” and the free space of the disk is “1 (GB).” Further, in the example depicted in FIG. 2, “virtual machine (1, 2)” in the virtual machine 3A represents that the use capacity of the memory to be used for operation of the virtual machine 3A is “1 (GB)” and the use capacity of the disk is “2 (GB).” It is to be noted that description of the other physical machines 2 and the other virtual machines 3 in FIG. 2 is omitted herein.

In such virtual machines 3 as depicted in FIG. 2, a manager would perform migration of a virtual machine 3 between physical machines 2 as occasion demands. Consequently, the manager can perform relocation of the virtual machines 3, for example, in response to a use situation of a service by a user. Therefore, the manager can implement efficient use of physical resources of the physical machines 2.

In particular, when migration of a virtual machine 3 is to be performed, the manager would perform migration of the virtual machine 3, for example, to a physical machine 2 that has a residual physical resource from among the physical machines 2 in which virtual machines 3 operate. However, in this case, the physical machines 2 from which a virtual machine 3 can migrate are limited to those physical machines 2 that currently have a residual physical resource. Therefore, the placement of the virtual machines 3 after the migration of a virtual machine 3 is sometimes different from optimum placement of the virtual machines 3, for example, from the point of view of efficient use of physical resources of the physical machines 2.

In contrast, the manager would sometimes use, for example, the mathematical planning (for example, optimization solver). Therefore, the manager can calculate optimum placement of the virtual machines 3 by which physical resources of the physical machines 2 can be used most efficiently as indicated by arrow marks in FIG. 3. However, the placement of the virtual machines 3 calculated by the mathematical planning does not take a situation of residual physical resources of the physical machines 2 during migration of the virtual machines 3 into consideration.

In particular, in the example depicted in FIG. 3, the manager may be required to migrate the virtual machine 3A and the virtual machine 3B from the physical machine 2A to the physical machine 2E. The total use capacity of the memories of the virtual machine 3A and the virtual machine 3B is “2 (GB),” and the total use capacity of the disks of the virtual machine 3A and the virtual machine 3B is “3 (GB).” Accordingly, in order to migrate the virtual machine 3A and the virtual machine 3B from the physical machine 2A to the physical machine 2E, it may be required that the free capacity of the memory of the physical machine 2E is equal to or greater than “2 (GB)” and the free capacity of the disk of the physical machine 2E is equal to or greater than “3 (GB).”

However, in the example depicted in FIG. 3, the free capacity of the memory of the physical machine 2E is “1 (GB)” and the free capacity of the disk of the physical machine 2E is “2 (GB).” Therefore, it is difficult to simultaneously migrate the virtual machine 3A and the virtual machine 3B to the physical machine 2E as depicted in FIG. 3. In particular, the virtual machine 3 that fails to be migrated immediately to the physical machine 2E from between the virtual machine 3A and the virtual machine 3B may be required to be migrated after the virtual machine 3E is migrated from the physical machine 2E to the physical machine 2D.

Further, in the example depicted in FIG. 3, the manager may be required to migrate the virtual machine 3C from the physical machine 2B to the physical machine 2F and migrate the virtual machine 3F from the physical machine 2F to the physical machine 2B. The use capacity of the memory of the virtual machine 3C is “2 (GB)” and the use capacity of the disk of the virtual machine 3C is “2 (GB).” Further, the use capacity of the memory of the virtual machine 3F is “2 (GB)” and the use capacity of the disk of the virtual machine 3F is “2 (GB).” Accordingly, in order to migrate the virtual machine 3C from the physical machine 2B to the physical machine 2F, it may be required that the free capacity of the memory of the physical machine 2F is equal to or greater than “2 (GB)” and the free capacity of the disk of the physical machine 2F is equal to or greater than “2 (GB).” Further, in order to migrate the virtual machine 3F from the physical machine 2F to the physical machine 2B, it may be required that the free capacity of the memory of the physical machine 2B is equal to or greater than “2 (GB)” and the free capacity of the disk of the physical machine 2B is equal to or greater than “2 (GB).”

However, in the example depicted in FIG. 3, the free capacity of the memory of the physical machine 2F is “0 (GB)” and the free capacity of the disk of the physical machine 2F is “1 (GB).” Further, in the example depicted in FIG. 3, the free capacity of the memory of the physical machine 2B is “0 (GB)” and the free capacity of the disk of the physical machine 2B is “0 (GB).” Therefore, the virtual machine 3C and the virtual machine 3F fail to simultaneously migrate to the physical machines 2 of the respective migration destinations.

Further, in the example depicted in FIG. 3, the manager may be required to migrate the virtual machine 3D from the physical machine 2D to the physical machine 2A. The use capacity of the memory of the virtual machine 3D is “1 (GB)” and the use capacity of the disk of the virtual machine 3D is “1 (GB).” Accordingly, in order to migrate the virtual machine 3D from the physical machine 2D to the physical machine 2A, it may be required that the free capacity of the memory of the physical machine 2A is equal to or greater than “1 (GB)” and the free capacity of the disk of the physical machine 2A is equal to or greater than “1 (GB).”

However, in the example depicted in FIG. 3, the free capacity of the memory of the physical machine 2A is “0 (GB)” and the free capacity of the disk of the physical machine 2A is “1 (GB).” Therefore, the virtual machine 3D fails to migrate to the physical machine 2A. In particular, in this case, it may be required that the migration to the physical machine 2A is performed after the virtual machine 3A or the virtual machine 3B is migrated from the physical machine 2A to the physical machine 2E.

Therefore, when the manager calculates optimum placement using the mathematical planning, it is sometimes difficult to specify an order of migration of the virtual machines 3 for relocating the virtual machines 3 to optimum placement.

Therefore, the information processing apparatus 1 in the present embodiment issues a migration instruction to a virtual machine 3 that can migrate to a physical machine 2 of a migration destination from among a plurality of virtual machines 3 that migrate between physical machines 2. Then, the information processing apparatus 1 issues a retraction instruction to a virtual machine 3 that can be retracted to a physical machine 2 other than the physical machine 2 of the migration destination from among the virtual machines 3 to which a migration instruction to the physical machine 2 of the migration destination is not issued. Thereafter, the information processing apparatus 1 issues a migration instruction to the physical machine 2 of the migration destination to a virtual machine 3 that can migrate to the physical machine 2 of the migration destination from among the virtual machines 3 to which a migration instruction to the physical machine 2 of the migration destination is not issued.

In other words, the information processing apparatus 1 first performs migration of all virtual machines 3 that can migrate to the physical machines 2 of the migration destinations and then performs retraction of the virtual machines 3 that can be retracted to the physical machines 2 that are not the migration destinations and fail to migrate to the physical machines 2 of the migration destinations.

Consequently, the information processing apparatus 1 is permitted to generate a virtual machine 3 that can migrate to a physical machine 2 of the migration destination. Therefore, the information processing apparatus 1 can enhance the possibility that relocation of the virtual machines 3 may possibly be performed in accordance with optimum placement of the virtual machines 3 calculated by the mathematical planning.

[Hardware Configuration of Information Processing Apparatus]

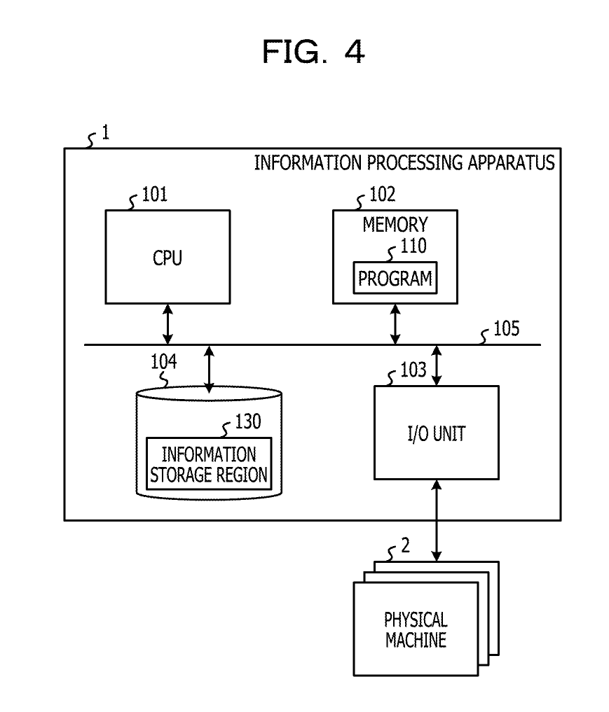

Now, a hardware configuration of the information processing apparatus 1 is described. FIG. 4 is a view depicting a hardware configuration of the information processing apparatus 1.

The information processing apparatus 1 includes a CPU 101 that is a processor, a memory 102, an external interface (input/output (I/O) unit) 103, and a storage medium (storage) 104. The components mentioned are coupled to each other by a bus 105.

The storage medium 104 stores a program 110 for performing a process (hereinafter referred to also as migration controlling process) for controlling migration of a virtual machine 3 into a program storage region (not depicted) in the storage medium 104.

The CPU 101 loads, upon execution of the program 110, the program 110 from the storage medium 104 into the memory 102 and cooperates with the program 110 to perform the migration controlling process.

The storage medium 104 includes an information storage region 130 (hereinafter referred to also as storage unit 130) for storing information to be used, for example, when the migration controlling process is performed. Meanwhile, the external interface 103 performs communication with the physical machines 2.

[Software Configuration of Information Processing Apparatus]

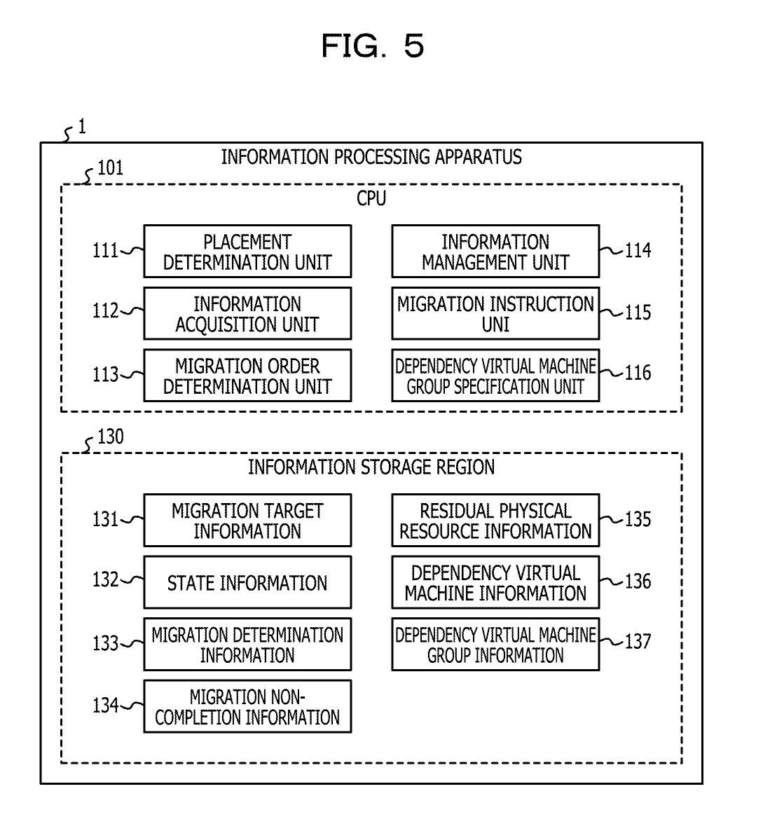

Now, a software configuration of the information processing apparatus 1 is described. FIG. 5 is a functional block diagram of the information processing apparatus 1 of FIG. 4. The CPU 101 operates, through cooperation with the program 110, as placement determination unit 111, an information acquisition unit 112, a migration order determination unit 113, an information management unit 114, a migration instruction unit 115 and a dependency virtual machine group specification unit 116.

Further, as depicted in FIG. 5, the information storage region 130 stores migration target information 131 (hereinafter referred to merely as migration target information 131), state information 132, migration determination information 133 and migration non-completion information 134. Furthermore, as depicted in FIG. 5, the information storage region 130 stores residual physical resource information 135, dependency virtual machine information 136 and dependency virtual machine group information 137.

The placement determination unit 111 calculates optimum placement of the virtual machines 3 by which physical resources of the physical machines 2 can be used most efficiently by using the mathematical planning (for example, an optimization solver). Then, the placement determination unit 111 creates the migration target information 131 including information relating to the calculated optimum placement. The migration target information 131 is information that associates, for each of the plurality of virtual machines 3 to migrate between the physical machines 2, information of the virtual machine 3 (for example, information capable of identifying the virtual machine 3), information of a physical machine 2 of the migration source of the virtual machine 3 and information of a physical machine 2 of the migration destination of the virtual machine 3 with one another. It is to be noted that the information of the physical machine 2 of the migration destination of the virtual machine 3 is information of the physical machine 2 of the migration destination of the virtual machine 3 that is to be migrated when the virtual machines 3 are relocated to the optimum placement. An example of the migration target information 131 is hereinafter described.

The information acquisition unit 112 acquires the migration target information 131 created by the placement determination unit 111. Further, the information acquisition unit 112 acquires the state information 132 (hereinafter referred to also as first state information 132a) representative of a state of each of the plurality of physical machines 2 and the plurality of virtual machines 3. The state information 132 is, for example, information of a free capacity of each of physical resources of the plurality of physical machines 2 and information of a use capacity of the physical resource used for operation of each of the plurality of virtual machines 3. An example of the state information 132 is hereinafter described.

The information acquisition unit 112 further acquires, after retraction of a virtual machine 3, the state information 132 (hereinafter referred to also as second state information 132b) after the retraction of the virtual machine 3.

The migration order determination unit 113 specifies a virtual machine 3 that can be migrated to a physical machine 2 of the migration destination from among the plurality of virtual machines 3 on the basis of the migration target information 131 and the state information 132 (first state information 132a or second state information 132b) acquired by the information acquisition unit 112. Then, the migration instruction unit 115 instructs the virtual machine 3 specified by the migration order determination unit 113 to migrate to the physical machine 2 of the migration destination.

Further, the migration order determination unit 113 specifies, from among the virtual machines 3 to which the migration instruction unit 115 does not issue a migration instruction to a physical machine 2 of the migration destination, a virtual machine 3 that can be retracted to a physical machine 2 other than the physical machine 2 of the migration destination. Then, the migration instruction unit 115 instructs the virtual machine 3 specified by the migration order determination unit 113 to retract.

The information management unit 114 performs updating of the migration determination information 133, migration non-completion information 134 and residual physical resource information 135 in response to migration of a virtual machine 3 to a physical machine 2 of the migration destination. The migration determination information 133, migration non-completion information 134 and residual physical resource information 135 are hereinafter described.

The dependency virtual machine group specification unit 116 specifies virtual machines 3 that are to be migrated previously (each of such virtual machines 3 is hereinafter referred to also as dependency virtual machine 31) in order to allow migration of a virtual machine 3 to a physical machine 2 of the migration destination. Then, the dependency virtual machine group specification unit 116 creates the dependency virtual machine information 136 including information of the specified dependency virtual machines 31. An example of the dependency virtual machine information 136 is hereinafter described.

Thereafter, the dependency virtual machine group specification unit 116 specifies, from among the dependency virtual machines 31, a dependency virtual machine group 32 that includes two or more virtual machines 3 having a circulating relationship between a dependency virtual machine 31 and a virtual machine 3 that is permitted to migrate to the physical machine 2 of the migration destination by migrating the dependency virtual machine 31 previously. In particular, two or more virtual machines 3 having a circulating relationship are two or more virtual machines 3 having a relationship that, from among the dependency virtual machines 31, each virtual machine 3 is a dependency virtual machine 31 of a different virtual machine 3 and a dependency virtual machine 31 of each virtual machine 3 is the different virtual machine 3. Then, the dependency virtual machine group specification unit 116 creates the dependency virtual machine group information 137 including information of the specified dependency virtual machine group 32. An example of the dependency virtual machine group information 137 is hereinafter described.

Further, in this case, the migration instruction unit 115 issues a retraction instruction to one virtual machine 3 that can be retracted into a physical machine 2 other than the physical machine 2 of the migration destination and is included in each dependency virtual machine group 32. It is to be noted that the dependency virtual machine group specification unit 116 may store the created dependency virtual machine information 136 and dependency virtual machine group information 137 into the information storage region 130.

It is to be noted that, in the following description, physical resources of a physical machine 2 are a memory capacity and a capacity of a disk of the physical machine 2. However, physical resources of a physical machine 2 may be, for example, a number of CPUs or a use rate or the like of a CPU. Further, the information processing apparatus 1 may execute a migration controlling process by utilizing one or more pieces of information selected, for example, from a memory capacity, a disk capacity, a number of CPU and an amount of CPU.

### Outline of First Embodiment

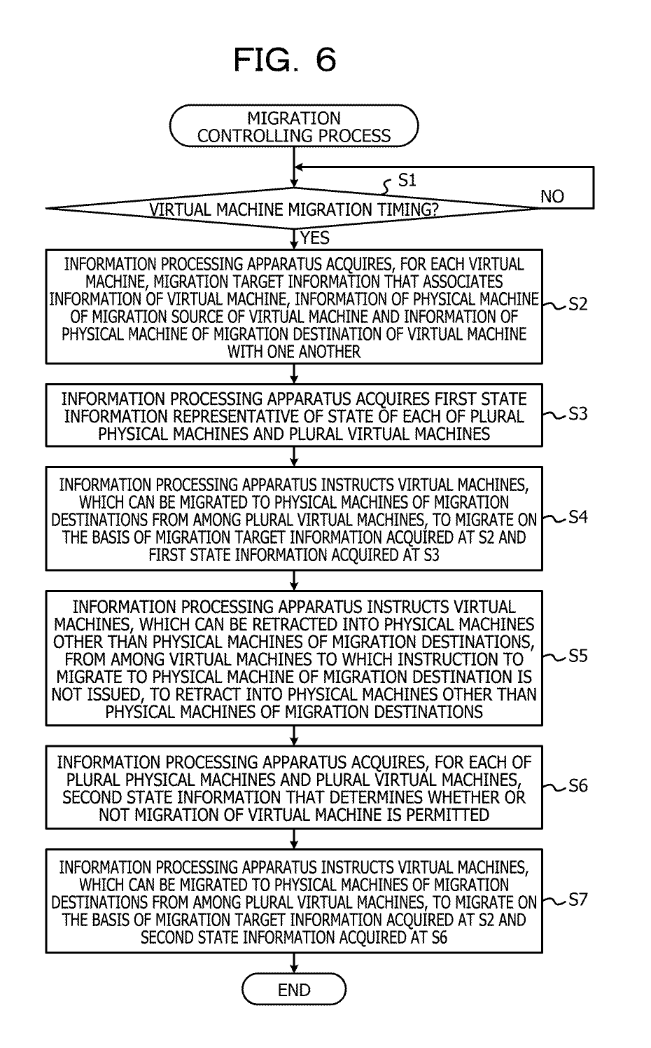

Now, an outline of a first embodiment is described. FIG. 6 is a flow chart illustrating an outline of a migration controlling method according to the first embodiment.

As depicted in FIG. 6, the information processing apparatus 1 waits till a migration timing of a virtual machine 3 (NO at S1). The migration timing of a virtual machine 3 may be a timing determined by the manager, for example, as timing at which relocation of the virtual machines 3 is to be performed. In particular, the migration timing of a virtual machine 3 may be a timing determined as timing at which the manager is to perform relocation of the virtual machines 3 in response to appearance of a physical machine 2 in which the use rate of a physical resource exceeds a given threshold value from among the physical machines 2 in which the virtual machines 3 are deployed.

Thereafter, when the migration timing of a virtual machine 3 comes (YES at S1), the information processing apparatus 1 acquires, for each virtual machine 3, the migration target information 131 that associates information of the virtual machine 3, information of a physical machine 2 of the migration source of the virtual machine 3 and information of a physical machine 2 of the migration destination of the virtual machine 3 with one another (S2). Further, the information processing apparatus 1 acquires the first state information 132a representative of the state of each of the plurality of physical machines 2 and the plurality of virtual machines 3 (S3). In other words, the information processing apparatus 1 acquires, when the migration timing of a virtual machine 3 comes, information to be used when an order of migration of the virtual machines 3 (migration order for relocating the virtual machines 3 to optimum placement) is determined.

Then, the information processing apparatus 1 instructs virtual machines 3, which can be migrated to the physical machines 2 of the migration destinations from among the plurality of virtual machines 3, to migrate on the basis of the migration target information 131 acquired by the process at step S2 and the first state information 132a acquired by the process at step S3 (S4). Then, the information processing apparatus 1 instructs the virtual machines 3, which can be retracted into physical machines 2 other than the physical machines 2 of the migration destinations, from among the virtual machines 3 to which an instruction to migrate to a physical machine 2 of a migration destination is not issued, to retract into physical machines 2 other than the physical machines 2 of the migration destinations (S5).

In particular, the information processing apparatus 1 performs, as the process at step S4, migration of the virtual machines 3 to physical machines 2 that include a residual physical resource to be used for operation of the virtual machines 3 from among the physical machines 2 of the migration destinations of the virtual machines 3. Therefore, the state after the process at step S4 is completed is a state in which the virtual machines 3 that can be migrated to the physical machines 2 of the migration destinations do not exist among the virtual machines 3. Here, the information processing apparatus 1 in the present embodiment retracts, in the process at step S5, from among the virtual machines 3, virtual machines 3 that are not permitted to migrate to the physical machines 2 of the migration destinations but can be retracted into physical machines 2 other than the physical machines of the migration destinations. Consequently, the information processing apparatus 1 is allowed to generate a virtual machine 3, which is permitted to migrate to the physical machine 2 of the migration destination, again.

Then, the information processing apparatus 1 acquires, for each of the plurality of physical machines 2 and the plurality of virtual machines 3, the second state information 132b that determines whether or not migration of a virtual machine 3 is permitted (S6).

In particular, it is demanded for the information processing apparatus 1 to determine whether or not a result when retraction of a virtual machine 3 is performed by the process at step S5 gives rise to appearance of a virtual machine 3 that is made possible to migrate to a physical machine 2 of the migration destination. Therefore, in the process at step S6, the information processing apparatus 1 acquires the second state information 132b, which includes information of the physical machines 2 and the virtual machines 3 after the process at step S5, in order to determine whether or not a virtual machine 3 that is enabled to migrate to the physical machine 2 of the migration destination has appeared.

Thereafter, the information processing apparatus 1 instructs the virtual machines 3, which can be migrated to the physical machines 2 of the migration destinations from among the plurality of virtual machines 3, to migrate on the basis of the migration target information 131 acquired by the process at step S2 and the second state information 132b acquired by the process at step S6 (S7). Consequently, it is possible for the information processing apparatus 1 to enhance the possibility that it may be possible to perform relocation of the virtual machines 3 while complying with the optimum placement calculated by using the mathematical planning by the manager.

It is to be noted that, if the optimum placement of the virtual machines 3 calculated by the manager is not implemented after the process at step S7 is completed, then the information processing apparatus 1 may repetitively perform the processes at steps S5 to S7 until the optimum placement of the virtual machines 3 is implemented.

In this manner, the information processing apparatus 1 acquires, for each virtual machine 3, the migration target information 131 including information that associates information of the virtual machine 3, information of a physical machine 2 of the migration source of the virtual machine 3 and information of a physical machine 2 of the migration destination of the virtual machine 3. Further, the information processing apparatus 1 acquires the first state information 132a indicative of a state of each of the plurality of physical machines 2 and the plurality of virtual machines 3. Then, the information processing apparatus 1 issues an instruction to virtual machines 3 that can migrate to the physical machines 2 of the migration destinations from among the plurality of virtual machines 3 to migrate to the physical machines 2 of the migration destinations on the basis of the migration target information 131 and the first state information 132a.

Then, the information processing apparatus 1 instructs virtual machines 3, which can be retracted to physical machines 2 other than the physical machines 2 of the migration destinations from among the virtual machines 3 to which an instruction to migrate to a physical machine 2 of a migration destination is not issued, to retract into physical machines 2 other than the physical machines 2 of the migration destinations. Thereafter, the information processing apparatus 1 acquires the second state information 132b for determining, for each of the plurality of physical machines 2 and the plurality of virtual machines 3 after the retraction of the virtual machines 3, whether or not migration of the virtual machine 3 is permitted. Further, the information processing apparatus 1 instructs, on the basis of the migration target information 131 and the second state information 132b, the virtual machines 3, which can migrate to the physical machines 2 of the migration destinations from among the virtual machines 3 to which a migration instruction to a physical machine 2 of a migration destination is not issued, to migrate to the physical machines 2 of the migration destinations.

In particular, the information processing apparatus 1 successively performs migration to a physical machine 2 of the migration destination while performing retraction of a virtual machine 3 on the basis of the migration target information 131 and the state information 132. Consequently, even where it is difficult to migrate a plurality of virtual machines 3 at the same time, for example, the information processing apparatus 1 can perform relocation of the virtual machines 3 so as to implement optimum placement of the virtual machines 3 calculated by the manager.

### Details of First Embodiment

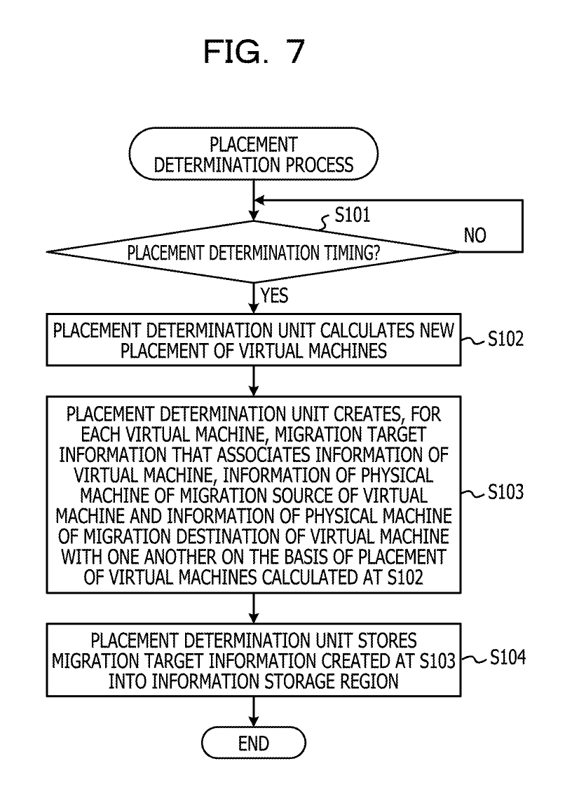

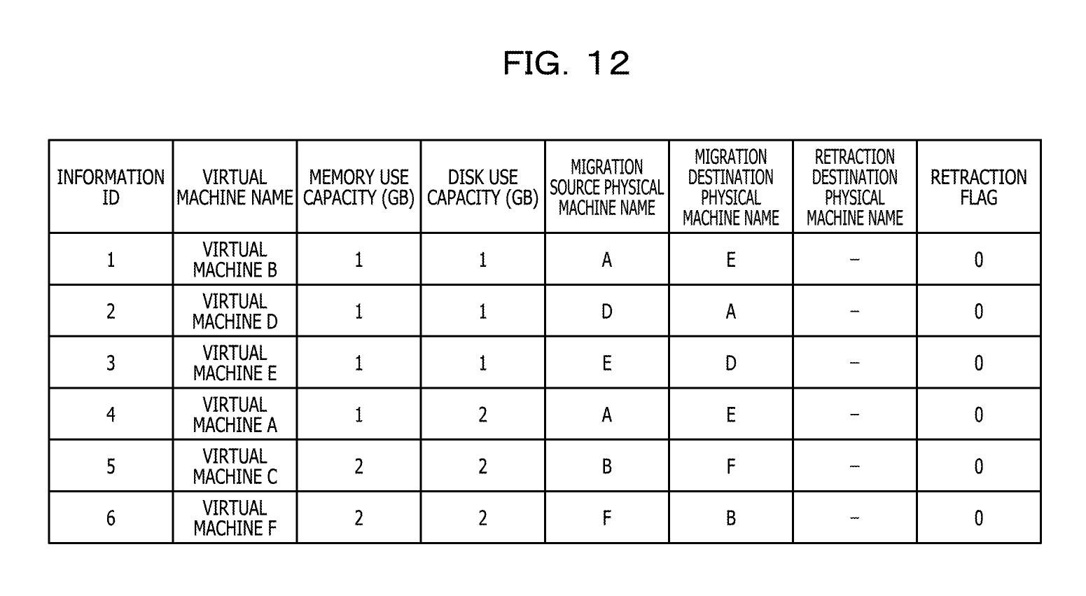

Now, details of the first embodiment are described. FIGS. 7 to 11 are flow charts illustrating details of the migration controlling process in the first embodiment. Further, FIGS. 12 to 35 are views illustrating details of the migration controlling method according to the first embodiment. The migration controlling process of FIGS. 7 to 11 is described with reference to FIGS. 12 to 35.

[Placement Determination Process]

First, a process that is executed, for example, before the migration controlling process according to the first embodiment is performed and determines optimum placement of the virtual machines 3 (the process is hereinafter referred to also as placement determination process) is described. FIG. 7 is a flow chart illustrating the placement determination process in the first embodiment.

As depicted in FIG. 7, the placement determination unit 111 waits till a placement determination timing (NO at S101). The placement determination timing may be a timing determined, for example, by the manager as timing at which relocation of the virtual machines 3 is to be performed. In particular, the placement determination timing may be a timing determined by the manager as timing at which relocation of the virtual machines 3 is to be performed in response to an appearance of a physical machine 2 in which the use rate of a physical resource exceeds a given threshold value from among the physical machines 2 in which the virtual machines 3 are deployed.

Then, when the placement determination timing comes (YES at S101), the placement determination unit 111 calculates (determines) new placement (optimum placement) of the virtual machines 3 (S102). In particular, the placement determination unit 111 calculates optimum placement of the virtual machines 3, by which the physical resources of the physical machines 2 can be used efficiently, by using, for example, the mathematical planning.

Thereafter, the placement determination unit 111 creates the migration target information 131 on the basis of the optimum placement of the virtual machines 3 calculated by the process at step S102 (S103). In particular, the placement determination unit 111 associates, for each virtual machine 3, information of the virtual machine 3, information of a physical machine 2 of the migration source of the virtual machine 3 and information of a physical machine 2 of the migration destination of the virtual machine 3 with one another to create the migration target information 131. In the following, an example of the migration target information 131 is described.

FIG. 12 is a view illustrating an example of the migration target information 131. In the following, description is given of a case in which the placement determination unit 111 determines to change the placement of the virtual machines 3 described hereinabove with reference to FIG. 2 to the placement of the virtual machines 3 described hereinabove with reference to FIG. 3. It is to be noted that the physical machines 2A, 2B, 2C, 2D, 2E and 2F described hereinabove with reference to FIG. 2 and so forth are hereinafter referred to as physical machines A, B, C, D, E and F, or merely to A, B, C, D, E and F, respectively. Further, the virtual machines 3A, 3B, 3C, 3D, 3E and 3F described hereinabove with reference to FIG. 2 and so forth are hereinafter referred to as virtual machines A, B, C, D, E and F, or merely to A, B, C, D, E and F, respectively.

The migration target information 131 depicted in FIG. 12 includes, as items, “information identification (ID)” for identifying each piece of information included in the migration target information 131, “virtual machine name” indicative of a name of each virtual machine 3, and “memory use capacity” indicative of a use capacity of a memory to be used for operation of the virtual machine 3. The migration target information 131 depicted in FIG. 12 further includes, as items, “disk use capacity” indicative of a use capacity of a disk to be used for operation of each virtual machine 3 and “migration source physical machine name” indicative of a name of the physical machine 2 of the migration source. The migration target information 131 depicted in FIG. 12 further includes, as items, “migration destination physical machine name” indicative of a name of the physical machine 2 of the migration destination, “retraction destination physical machine name” indicative of a name of the physical machine 2 of the retraction destination, and “retraction flag” that is a flag indicative of whether or not retraction has been performed.

In particular, in the migration target information 131 depicted in FIG. 12, to a piece of information whose “information ID” is “1,” “virtual machine B” is set as “virtual machine name,” “1 (GB)” is set as “memory use capacity,” and “1 (GB)” is set as “disk use capacity.” Further, in the migration target information 131 depicted in FIG. 12, to the piece of information whose “information ID” is “1,” “A” is set as “migration source physical machine name,” “E” is set as “migration destination physical machine name,” and “retraction destination physical machine name” is blank. Further, in the migration target information 131 depicted in FIG. 12, to the piece of information whose “information ID” is “1,” “0” is set as “retraction flag.” Description of the other information in FIG. 12 is omitted herein.

It is to be noted that the information management unit 114 may sort the pieces of information included in the migration target information 131 depicted in FIG. 12 in the ascending order of the total value of a value set in “memory use capacity” and a value set in “disk use capacity” (the total value is sometimes referred to simply as “total value”) as depicted in FIG. 12. In particular, in the migration target information 131 depicted in FIG. 12, the information is set in the order of the virtual machine B (total value is “2”), virtual machine D (total value is “2”), virtual machine E (total value is “2”), virtual machine A (total value is “3”), virtual machine C (total value is “4”) and virtual machine F (total value is “4”). Consequently, the information management unit 114 can perform migration of the virtual machines 3 in the ascending order of the total value. Therefore, the information management unit 114 can suppress the average time taken for migration of the virtual machines 3.

On the other hand, the information management unit 114 may sort the pieces of information included in the migration target information 131 depicted in FIG. 12 otherwise in the descending order of the total value of the value set in “memory use capacity” and the value set in “disk use capacity.” Consequently, the information management unit 114 can perform migration of the virtual machines 3 in the descending order of the total value. Therefore, the information management unit 114 can suppress the entire time taken for migration of the virtual machines 3.

Alternatively, the information management unit 114 may calculate, for each of the pieces of information included in the migration target information 131 depicted in FIG. 12, an evaluation value in accordance with an expression (1) given below and sort the pieces of information in the ascending order (or the descending order) of the calculated evaluation value.

Evaluation value=value set in “memory use capacity”×(average value of values set in “memory use capacity” of pieces of information included in migration target information 131/average value of values set in “disk use capacity” of pieces of information included in migration target information 131)+value set in “disk use capacity” Expression (1)

Further, the information management unit 114 may group those physical machines 2 that have a relationship of a physical machine 2 of the migration source of a virtual machine 3 and a physical machine 2 of the migration destination of the virtual machine 3. Then, the information management unit 114 may sort the pieces of information included in the migration target information 131 depicted in FIG. 12 such that migration of the virtual machines 3 deployed in the physical machines 2 belonging to the groups is performed in order.

In particular, in the example depicted in FIG. 3, the physical machines A, D and E are physical machines 2 of the migration sources or physical machines 2 of the migration destinations of the virtual machines A, B, D and E. Further, the physical machines B and F are physical machines 2 of the migration sources or physical machines 2 of the migration destinations of the virtual machines C and F. Therefore, the information management unit 114 determines, for example, the physical machines A, D and E as first group and the physical machines B and F as second group. Then, the information management unit 114 sorts the pieces of information included in the migration target information 131 depicted in FIG. 12 such that the virtual machines A, B, D and E deployed in the physical machines 2 of the first group and the virtual machines C and F deployed in the physical machines 2 of the second group may be arranged alternately as far as possible.

Consequently, the migration instruction unit 115 can perform migration of the virtual machines 3 to the physical machines 2 of the migration destinations in parallel as far as possible. Therefore, the migration instruction unit 115 can reduce time taken for migration of the virtual machines 3 to the physical machines 2 of the migration destinations.

It is to be noted that the information management unit 114 may store the created information relating to the groups into the information storage region 130. Consequently, the migration instruction unit 115 can perform migration of virtual machines 3 to the physical machines 2 of the migration destinations in parallel as far as possible by referring to the information relating to the groups stored in the information storage region 130.

Referring back to FIG. 7, the placement determination unit 111 stores the migration target information 131 created by the process at step S103 into the information storage region 130 (S104). Consequently, the migration order determination unit 113 can determine a migration order of the virtual machines 3 as hereinafter described.

[Details of Migration Controlling Process]

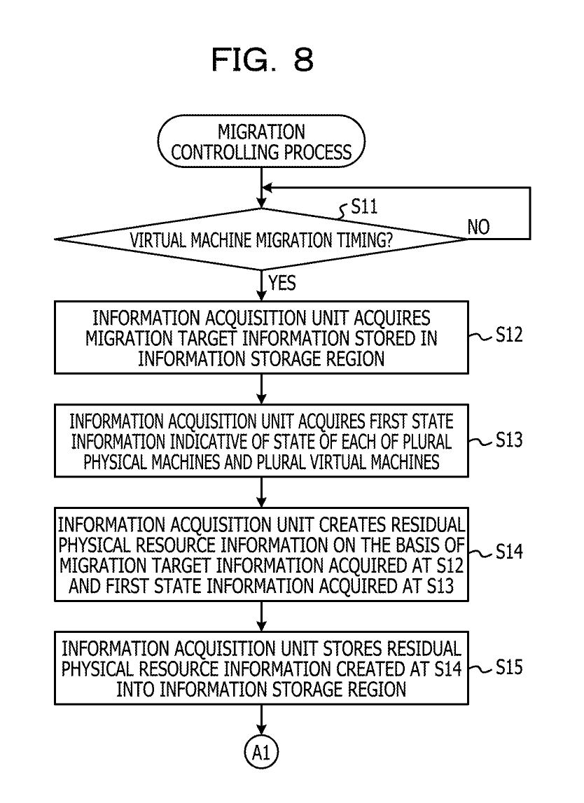

In the following, details of the migration controlling process in the first embodiment are described. FIGS. 8 to 11 are flow charts illustrating details of the migration controlling process in the first embodiment.

As depicted in FIG. 8, the information acquisition unit 112 waits till a migration timing of a virtual machine 3 (NO at S11). Then, when the migration timing of a virtual machine 3 comes (YES at S11), the information acquisition unit 112 acquires the migration target information 131 stored in the information storage region 130 (S12). Further, the information acquisition unit 112 acquires the first state information 132a indicative of a state of each of the plurality of physical machines 2 and the plurality of virtual machines 3 (S13). In the following, an example of the first state information 132a is described. It is to be noted that the first state information 132a relating to a physical machine 2 is hereinafter referred to also as physical machine state information 141a, and the first state information 132a relating to a virtual machine 3 is hereinafter referred to also as virtual machine state information 142a.

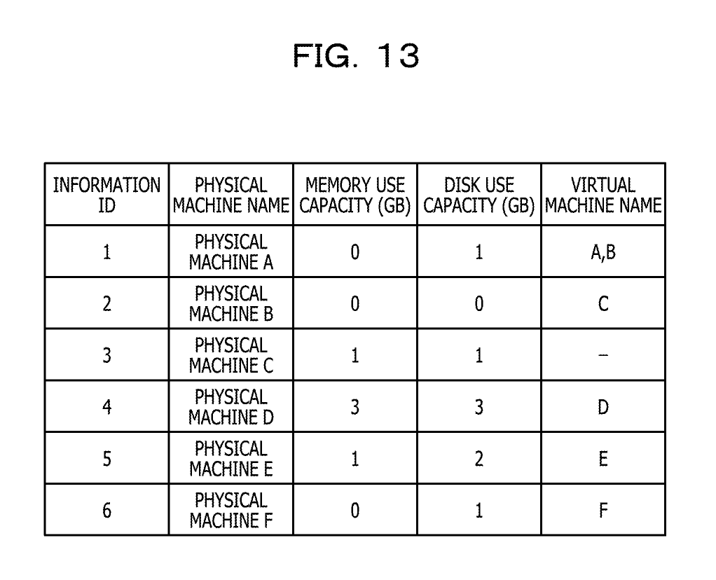

FIG. 13 is a view illustrating an example of the physical machine state information 141a. The physical machine state information 141a illustrated in FIG. 13 includes, as items, “information ID” for identifying each piece of information included in the physical machine state information 141a, and “memory free capacity” representative of a free capacity of the memory of each physical machine 2. The physical machine state information 141a illustrated in FIG. 13 further includes, as items, “disk free capacity” representative of a free capacity of the disk of the physical machine 2 and “virtual machine name” representative of a name of a virtual machine 3 deployed in the physical machine 2.

In particular, in the physical machine state information 141a illustrated in FIG. 13, to information whose “information ID” is “1,” “physical machine A” is set as “physical machine name.” Further, in the physical machine state information 141a illustrated in FIG. 13, to the information whose “information ID” is “1,” “0 (GB)” is set as “memory free capacity,” “1 (GB)” is set as “disk free capacity,” and “A, B” is set as “virtual machine name.” Description of the other information in FIG. 13 is omitted herein.

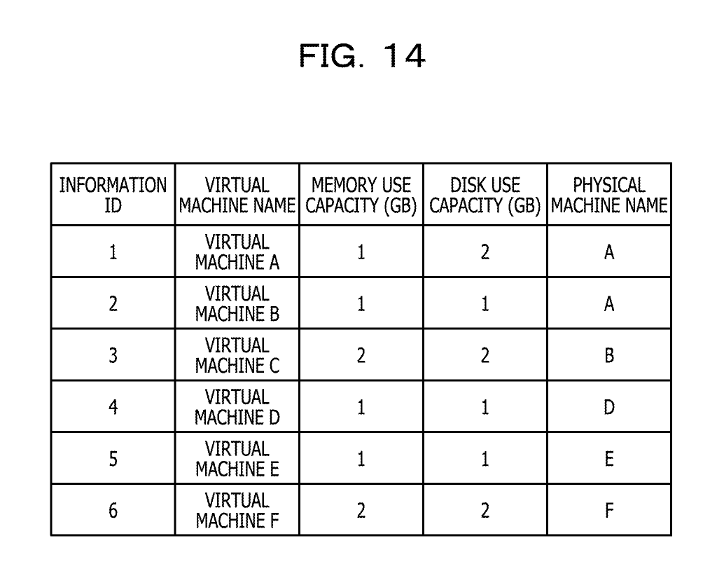

FIG. 14 is a view illustrating an example of the virtual machine state information 142a. The virtual machine state information 142a depicted in FIG. 14 includes, as items, “information ID” for identifying each piece of information included in the virtual machine state information 142a, and “memory use capacity” representative of a use capacity of a memory to be used for operation of each virtual machine 3. Further, the virtual machine state information 142a depicted in FIG. 14 includes, as items, “disk use capacity” representative of a use capacity of the disk to be used for operation of the virtual machine 3, and “physical machine name” representative of a name of a physical machine 2 in which the virtual machine 3 is deployed.

In particular, in the virtual machine state information 142a illustrated in FIG. 14, to information whose “information ID” is “1,” “virtual machine A” is set as “virtual machine name.” Further, in the virtual machine state information 142a illustrated in FIG. 14, to the information whose “information ID” is “1,” “1 (GB)” is set as “memory use capacity,” “2 (GB)” is set as “disk use capacity,” and “A” is set as “physical machine name.” Description of the other information in FIG. 14 is omitted herein.

Referring back to FIG. 8, the information acquisition unit 112 creates residual physical resource information 135 on the basis of the migration target information 131 acquired by the process at step S12 and the first state information 132a acquired by the process at step S13 (S14). The residual physical resource information 135 is information relating to residual physical resources at present of each physical machine 2. Then, the information acquisition unit 112 stores the residual physical resource information 135 created by the process at step S14 into the information storage region 130 (S15). In the following, an example of the residual physical resource information 135 is described.

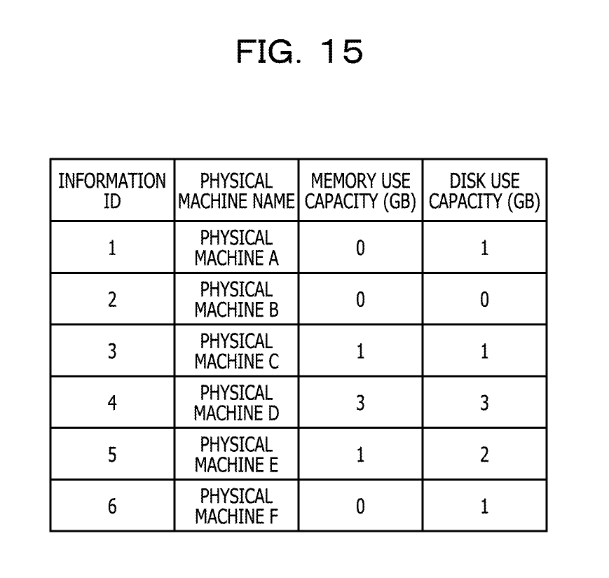

FIG. 15 is a view illustrating an example of the residual physical resource information 135. The residual physical resource information 135 illustrated in FIG. 15 includes, as items, “information ID” for identifying each piece of information included in the residual physical resource information 135 and “physical machine name” indicative of a name of each physical machine 2. The residual physical resource information 135 illustrated in FIG. 15 further includes, as items, “memory free capacity” representative of a free capacity of a memory of each physical machine 2, and “disk free capacity” representative of a free capacity of the disk of each physical machine 2.

In particular, in the residual physical resource information 135 illustrated in FIG. 15, to information whose “information ID” is “1,” “physical machine A” is set as “physical machine name.” Further, in the residual physical resource information 135 illustrated in FIG. 15, to the information whose “information ID” is “1,” “0 (GB)” is set as “memory free capacity,” and “1 (GB)” is set as “disk free capacity.” Description of the other information of FIG. 15 is omitted herein.

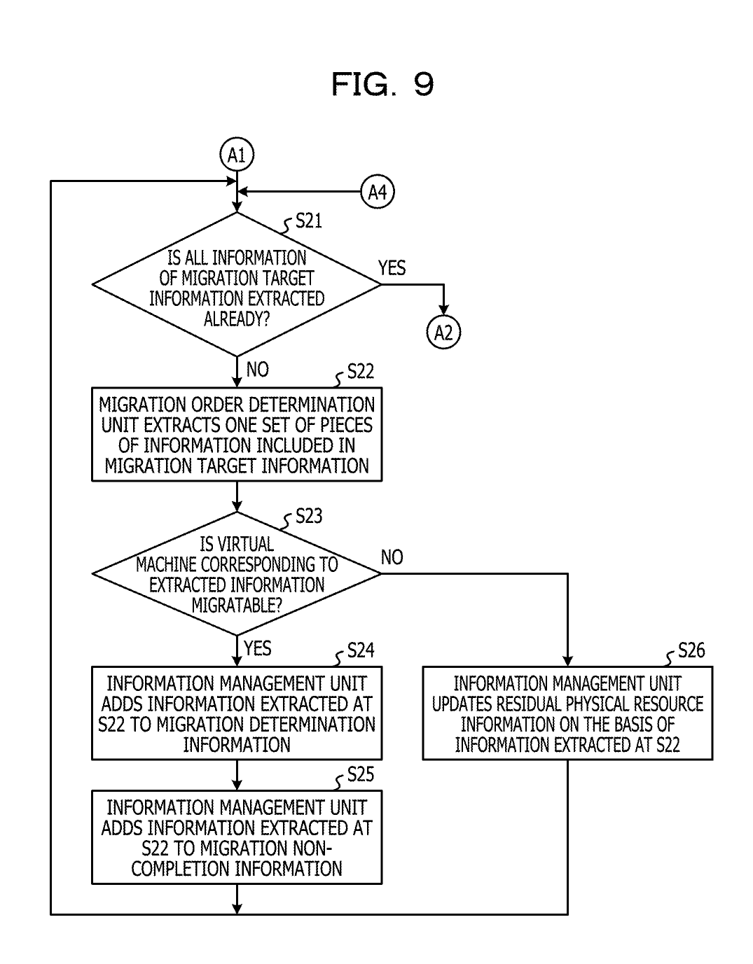

Referring back to FIG. 9, the migration order determination unit 113 determines whether or not all information included in the migration target information 131 is extracted already (S21). If it is determined that all information is not yet extracted (NO at step S21), then the migration order determination unit 113 extracts one set of pieces of information included in the migration target information 131 (S22). In particular, the migration order determination unit 113 acquires information corresponding to one row from the information included in the migration target information 131 illustrated in FIG. 12.

Then, the migration order determination unit 113 determines whether or not a virtual machine 3 corresponding to the information extracted by the process at step S22 is migratable to the physical machine 2 of the migration destination (S23). If it is determined that the virtual machine 3 is migratable to the physical machine 2 of the migration destination (YES at S23), then information management unit 114 adds the information extracted by the process at step S22 to the migration determination information 133 (S24).

Further, the information management unit 114 updates the residual physical resource information 135 on the basis of the information extracted by the process at step S22 (S25). In particular, the information management unit 114 performs updating of the residual physical resource information 135 assuming that the virtual machine 3 determined as migratable to the physical machine 2 of the migration destination has been migrated to the physical machine 2 of the migration destination.

On the other hand, if the virtual machine 3 corresponding to the information extracted by the process at step S22 is not migratable to the physical machine 2 of the migration destination (NO at S23), then the information management unit 114 adds the information extracted by the process at step S22 to the migration non-completion information 134 (S26).

Consequently, the information management unit 114 is allowed to separately manage information relating to the virtual machines 3 that can be migrated to the physical machines 2 of the migration destinations and information relating to the virtual machines 3 that are not migratable to the physical machines 2 of the migration destinations at present.

It is to be noted that the processes performed after the process at step S15 are performed until it is determined by the process at step S21 that all information included in the migration target information 131 is extracted already are hereinafter referred to also as migration virtual machine determination process.

[Example of Migration Virtual Machine Determination Process for the First Time]

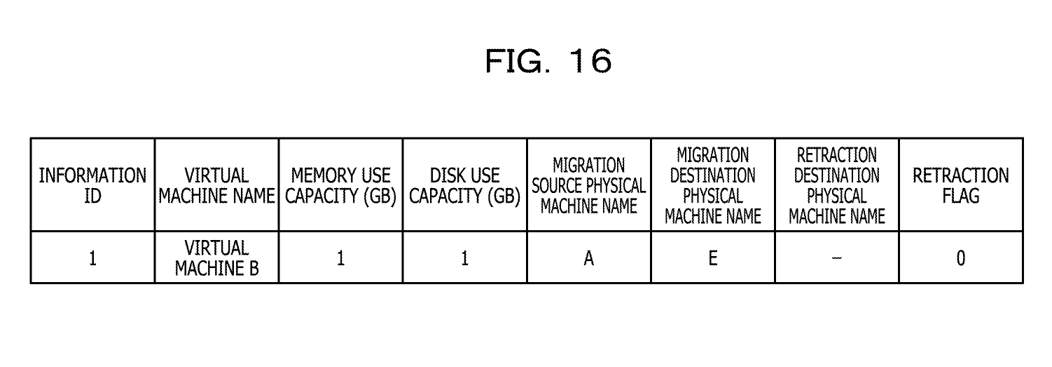

Now, an example of the migration virtual machine determination process is described. FIGS. 16 to 20 are views illustrating an example of the migration virtual machine determination process executed for the first time.

Referring back to FIG. 9, from the migration target information 131 depicted in FIG. 12, the migration order determination unit 113 first extracts information whose “information ID” is “1” (information whose “virtual machine name” is “virtual machine B”) (S22). Then, the migration order determination unit 113 acquires “1 (GB)” that is information set to the “memory use capacity” whose “information ID” is “1” and “1 (GB)” that is information set to “disk use capacity” whose “information ID” is “1.” Further, the migration order determination unit 113 acquires “E (physical machine E)” that is information set to “migration destination physical machine name” whose “information ID” is “1.”

Thereafter, the migration order determination unit 113 refers to the residual physical resource information 135 described hereinabove with reference to FIG. 15 to acquire “1 (GB)” that is information set to “memory free capacity” whose “physical machine name” is “physical machine E” and “2 (GB)” that is information set to “disk free capacity” whose “physical machine name” is “physical machine E.”

Here, from within the information acquired by the migration order determination unit 113, the information set to the “memory use capacity” and “disk use capacity” of the information of the virtual machine B is equal to or smaller than the information set to “memory free capacity” and “disk free capacity” of the physical machine E, respectively. Therefore, the migration order determination unit 113 determines that the virtual machine B that is the virtual machine 3 corresponding to the information extracted by the process at step S22 is migratable to the physical machine E that is the physical machine of the migration destination (YES at S23).

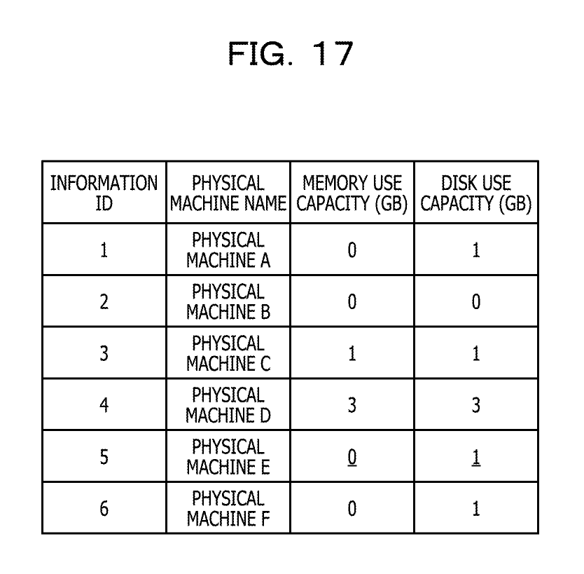

Accordingly, the information management unit 114 stores the information extracted by the process at step S22 (information whose “virtual machine name” is “virtual machine B” from within the migration target information 131 illustrated in FIG. 12) as migration determination information 133 into the information storage region 130 as depicted in FIG. 16 (S24). Further, the information management unit 114 updates “1 (GB)” that is the memory free capacity of the physical machine E in the residual physical resource information 135 illustrated in FIG. 15 into “0 (GB)” that is a value obtained by subtracting “1 (GB)” that is the memory use capacity of the virtual machine B from the memory free capacity as indicated at an underlined portion in FIG. 17 (S25). Further, the information management unit 114 updates “2 (GB)” that is the disk free capacity of the physical machine E in the residual physical resource information 135 depicted in FIG. 15 to “1 (GB)” that is a value obtained by subtracting “1 (GB)” that is the disk use capacity of the virtual machine B from the disk free capacity as indicated at an underlined portion in FIG. 17 (S25).

Thereafter, the migration order determination unit 113 repeats execution of the processes at steps S21 to S26 until all information included in the migration target information 131 depicted in FIG. 12 is extracted already. As a result, the migration order determination unit 113 determines, by the process at step S23, that the virtual machine B (information whose “information ID” in the migration target information 131 illustrated in FIG. 12 is “1”) and the virtual machine E (information whose “information ID” in the migration target information 131 illustrated in FIG. 12 is “3”) are migratable. On the other hand, the migration order determination unit 113 determines that the virtual machine D (information whose “information ID” in the migration target information 131 illustrated in FIG. 12 is “2”) and the virtual machine A (information whose “information ID” in the migration target information 131 depicted in FIG. 12 is “4”) are not migratable. Further, the migration order determination unit 113 determines that the virtual machine C (information whose “information ID” in the migration target information 131 depicted in FIG. 12 is “5”) and the virtual machine F (information whose “information ID” in the migration target information 131 illustrated in FIG. 12 is “6”) are not migratable.

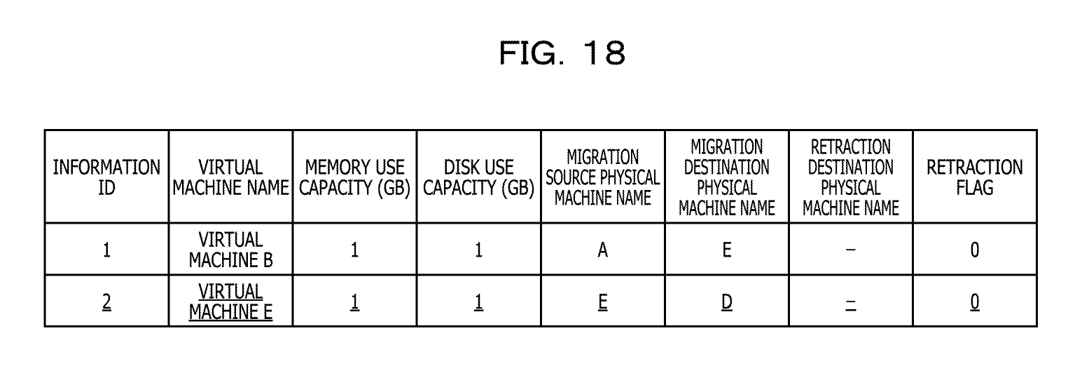

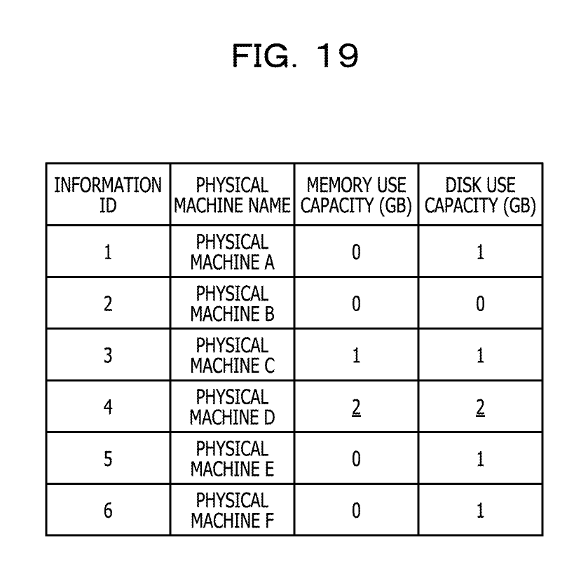

Accordingly, the information management unit 114 stores the information whose “information ID” is “3” from within the migration target information 131 illustrated in FIG. 12 as additional information to the migration determination information 133 illustrated in FIG. 16 into the information storage region 130 as indicated at underlined portions in FIG. 18 (S24). Further, the information management unit 114 updates “3 (GB)” that is the memory free capacity of the physical machine D in the residual physical resource information 135 described hereinabove with reference to FIG. 17 to “2 (GB)” that is a value obtained by subtracting “1 (GB)” that is the memory use capacity of the virtual machine E from the memory free capacity as indicated by an underlined portion in FIG. 19 (S25). Furthermore, the information management unit 114 updates “3 (GB)” that is the disk free capacity of the physical machine D in the residual physical resource information 135 illustrated in FIG. 17 to “2 (GB)” that is a value obtained by subtracting “1 (GB)” that is the disk use capacity of the virtual machine E from the disk free capacity as indicated by an underlined portion in FIG. 19 (S25).

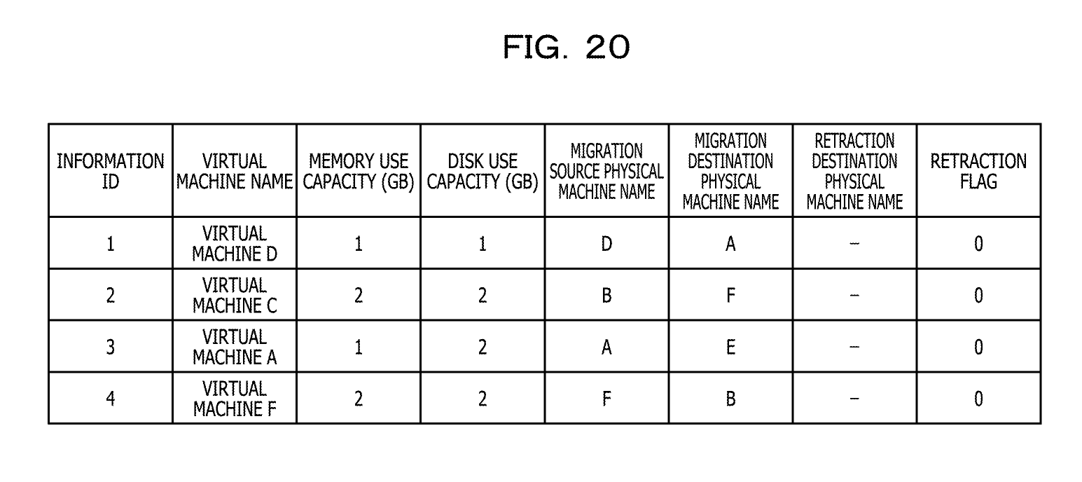

Further, the information management unit 114 stores the information whose “information ID” is “2” and “4” to “6” in the migration target information 131 illustrated in FIG. 12 as migration non-completion information 134 into the information storage region 130 as illustrated in FIG. 20 (S26).

It is to be noted that the migration order determination unit 113 may be configured to sort each piece of information included in the migration non-completion information 134, when the migration order determination unit 113 stores the migration non-completion information 134 into the information storage region 130. In particular, in this case, the migration order determination unit 113 specifies the virtual machines A, B, D and E deployed in the physical machines 2 of the first group described hereinabove with reference to FIG. 12 and the virtual machines C and F deployed in the physical machines 2 of the second group described hereinabove with reference to FIG. 12. Then, the migration order determination unit 113 sorts each piece of information of the migration non-completion information 134 such that the virtual machines 3 deployed in the physical machines 2 in the first group and the virtual machines 3 deployed in the physical machines 2 of the second group line up alternately as far as possible. Consequently, when information included in the migration non-completion information 134 is created as new migration target information 131, it becomes possible for the migration instruction unit 115 to perform migration of the virtual machines 3 to the physical machines 2 of the migration destinations in parallel as far as possible for each group as hereinafter described. Therefore, it becomes possible for the migration instruction unit 115 to reduce time taken for the migration of the virtual machines 3 to the physical machines 2 of the migration destinations.

Further, the migration target information 131 may be configured not to include the items of “memory use capacity” and “disk use capacity.” In this case, the migration order determination unit 113 may be configured to acquire information set to “memory use capacity” and “disk use capacity” corresponding to the virtual machines 3 by referring to the virtual machine state information 142a described hereinabove with reference to FIG. 14 in the process at step S22.

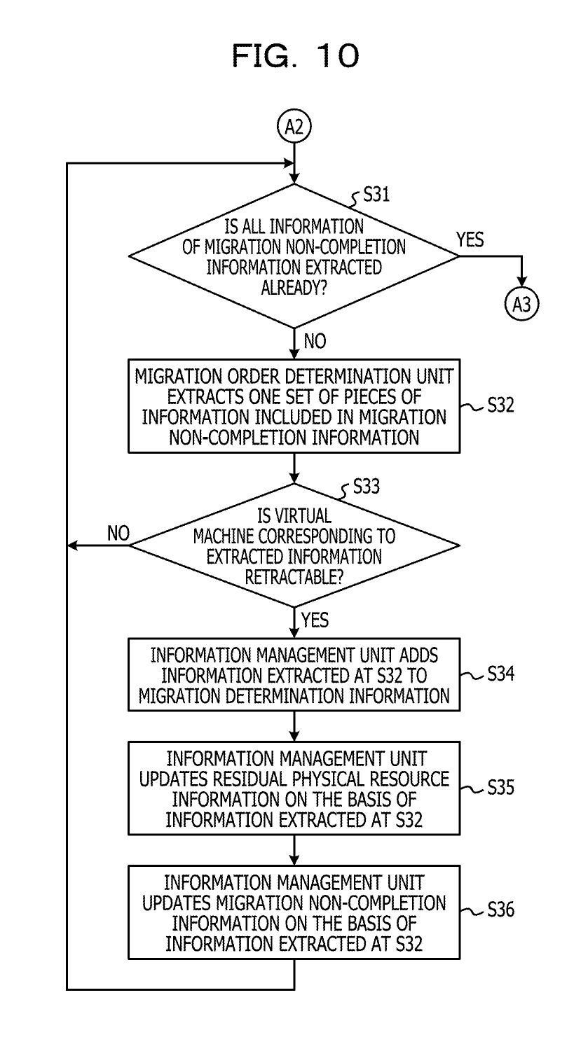

Referring back to FIG. 9, if all information included in the migration target information 131 is extracted already (YES at S21), then the migration order determination unit 113 determines whether or not all information included in the migration non-completion information 134 is extracted already (S31) as illustrated in FIG. 10. As a result, if it is determined that all information included in the migration non-completion information 134 is not yet extracted (NO at S31), then the migration order determination unit 113 extracts one set of pieces of information included in the migration non-completion information 134 (S32). In particular, the migration order determination unit 113 acquires information corresponding to one row from the information included in the migration non-completion information 134 illustrated in FIG. 20.

Then, the migration order determination unit 113 determines whether or not a virtual machine 3 corresponding to the information extracted by the process at step S32 can be retracted into a physical machine 2 other than the physical machine 2 of the migration destination (S33). If it is determined that the virtual machine 3 can be retracted into a physical machine 2 other than the physical machine 2 of the migration destination (YES at S33), then the information management unit 114 adds the information extracted by the process at step S32 to the migration determination information 133 (S34). Further, in this case, the information management unit 114 updates the residual physical resource information 135 on the basis of the information extracted by the process at step S32 (S35). Further, in this case, the information management unit 114 updates the migration non-completion information 134 on the basis of the information extracted by the process at step S32 (S36).

In particular, the migration order determination unit 113 performs retraction of a virtual machine 3 that is not permitted to migrate to the physical machine 2 of the migration destination at present but can be retracted into a physical machine 2 other than the physical machine 2 of the migration destination. Consequently, it becomes possible for the migration order determination unit 113 to generate a virtual machine 3 that can be migrated to the physical machine 2 of the migration destination even if the virtual machine 3 is not permitted at present to migrate to the physical machine 2 of the migration destination as hereinafter described.

On the other hand, if the virtual machine 3 corresponding to the information extracted by the process at step S32 is not retractable into a physical machine 2 other than the physical machine 2 of the migration destination (NO at S33), then the migration order determination unit 113 repetitively executes the processes at the steps beginning with step S31 until all information included in the migration non-completion information 134 illustrated in FIG. 20 is extracted.

It is to be noted that the processes after it is determined by the process at step S21 that all information included in the migration target information 131 is extracted already until it is determined by the process at step S31 that all information included in the migration non-completion information 134 is extracted already are hereinafter referred to also as retraction virtual machine determination process.

[Example of Retraction Virtual Machine Determination Process for the First Time]

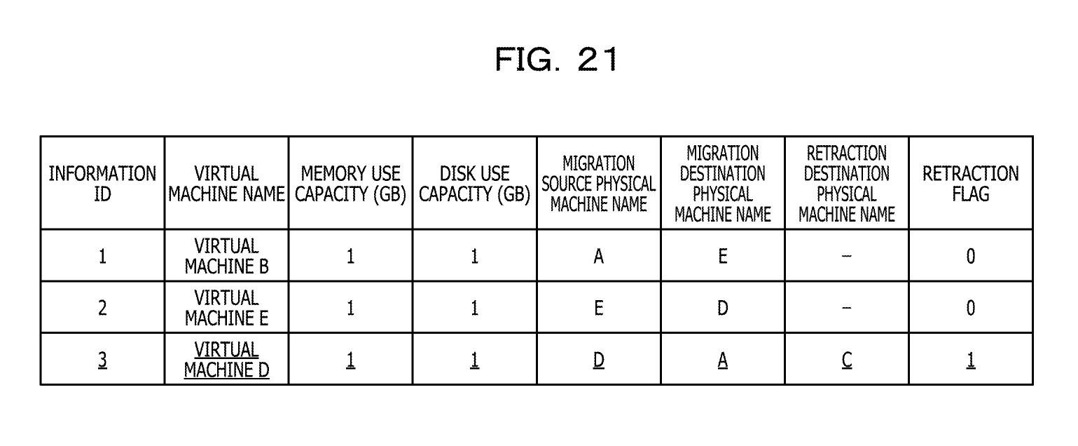

Now, an example of the retraction virtual machine determination process executed for the first time is described. FIGS. 21 to 26 are views illustrating an example of the retraction virtual machine determination process executed for the first time.

From the migration non-completion information 134 depicted in FIG. 20, the migration order determination unit 113 first extracts information whose “information ID” is “1” (information whose “virtual machine name” is “virtual machine D”) (S32).

Then, the migration order determination unit 113 acquires “1 (GB)” that is information set to “memory use capacity” whose “information ID” is “1” and “1 (GB)” that is information set to “disk use capacity” whose “information ID” is “1.” Further, the migration order determination unit 113 refers to the residual physical resource information 135 illustrated in FIG. 19 to specify a physical machine 2 that can retract the virtual machine D from which the information is acquired. In particular, in the residual physical resource information 135 illustrated in FIG. 19, “memory free capacity” and “disk free capacity,” for example, of information whose “information ID” is “3” (information whose “physical machine name” is “physical machine C”) are “1 (GB)” and “1 (GB),” respectively. Therefore, the memory use capacity and the disk use capacity of the virtual machine D are equal to or smaller than the memory free capacity and the disk free capacity of the physical machine C, respectively. Accordingly, the migration order determination unit 113 determines that the virtual machine D that is a virtual machine 3 corresponding to the information extracted by the process at step S32 is retractable into the physical machine C that is a physical machine 2 other than the physical machine 2 of the migration destination (YES at S 33).

It is to be noted that, in the process at step S33, the migration order determination unit 113 may not retract a virtual machine 3 corresponding to the information in which “1” is set to “retraction flag” from within the information included in the migration non-completion information 134, to a physical machine 2 other than the physical machine 2 of the migration destination. This makes it possible for the migration order determination unit 113 to suppress retraction of a virtual machine 3 that may not be retracted from being performed repetitively and efficiency perform migration of a virtual machine 3 to the physical machine 2 of the migration destination.

However, only when information is not included in the migration determination information 133, the migration order determination unit 113 may perform retraction also of a virtual machine 3 corresponding to the information in which “1” is set to “retraction flag” from within the information included in the migration non-completion information 134. In particular, when the process at step S33 is performed, if information is not included in the migration determination information 133, then the possibility that the information processing apparatus 1 may fail in relocation of the virtual machines 3 in accordance with optimum placement calculated by the manager is high as hereinafter described. Therefore, in this case, the migration order determination unit 113 may determine also a virtual machine 3 corresponding to the information in which “1” is set to “retraction flag” as virtual machine 3 to be retracted. This makes it possible for the migration order determination unit 113 to raise the possibility that relocation of the virtual machines 3 in accordance with optimum placement may possibly be performed.

Then, the migration order determination unit 113 stores the information extracted by the process at step S32 (information whose “virtual machine name” is “virtual machine D”) as migration determination information 133 into the information storage region 130 as indicated by underlined portions in FIG. 21 (S34). In particular, the migration order determination unit 113 sets the information, whose “information ID” is “1,” of the migration non-completion information 134 illustrated in FIG. 20 as information, whose “information ID” is “3,” of the migration determination information 133 as indicated by underlined portions in FIG. 21.

Here, in this case, the migration order determination unit 113 sets “C” indicative of the physical machine C having the virtual machine D retracted therein to “retraction destination physical machine name” in the information whose “information ID” is “3” in the migration determination information 133 as indicated by an underlined portion of FIG. 21. This makes it possible for the migration order determination unit 113 to appropriately manage the information of the physical machine 2 of the migration source when the virtual machine D after retracted is migrated to the physical machine 2 of the migration destination. Further, the migration order determination unit 113 sets “1” to “retraction flag” as indicated by an underlined portion in FIG. 21. This makes it possible for the migration order determination unit 113 to specify, when the process at step S33 is executed again, the virtual machine 3 retracted already in a physical machine 2 other than the physical machine 2 of the migration destination (virtual machine 3 determined already to be retracted).

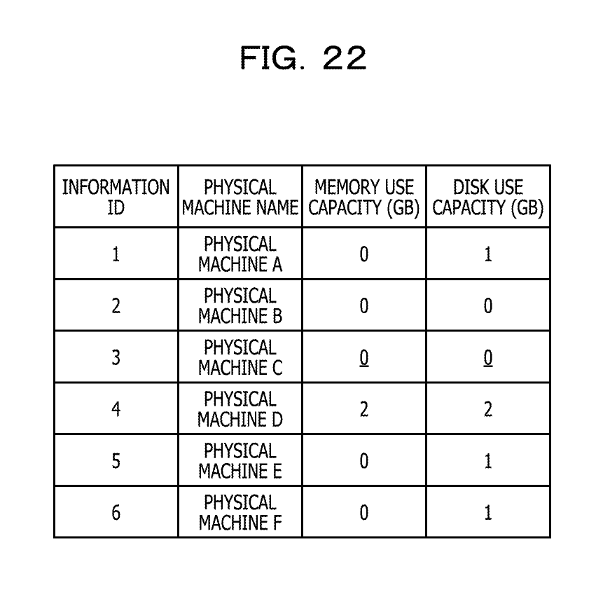

Further, the information management unit 114 updates “1 (GB)” that is the memory free capacity of the physical machine C of the residual physical resource information 135 illustrated in FIG. 19 to “0 (GB)” that is a value obtained by subtracting “1 (GB)” that is the memory use capacity of the virtual machine D from the memory free capacity as indicated by an underlined portion in FIG. 22 (S35). Then, the information management unit 114 updates “1 (GB)” that is the disk free capacity of the physical machine C in the residual physical resource information 135 illustrated in FIG. 19 to “0 (GB)” that is a value obtained by subtracting “1 (GB)” that is the disk use capacity of the virtual machine D from the disk free capacity as indicated by an underlined portion in FIG. 22 (S35).

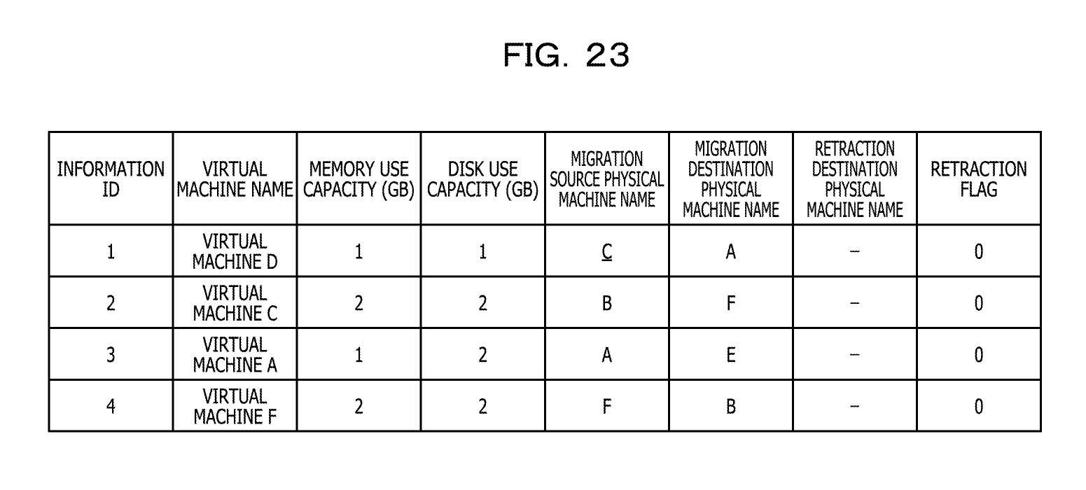

Furthermore, the information management unit 114 updates the information set to “migration source physical machine name” of the virtual machine D to the physical machine C that is the physical machine 2 into which the virtual machine D is to be retracted as indicated by an underlined portion in FIG. 23. This makes it possible for the information management unit 114 to reflect the state of the virtual machine D by performing retraction of the virtual machine D upon the migration non-completion information 134.

Thereafter, the migration order determination unit 113 repeats execution of the processes at steps S31 to S36 until all information included in the migration non-completion information 134 illustrated in FIG. 20 is extracted already. As a result, the migration order determination unit 113 determines in the process at step S33 that the virtual machine D (information whose “information ID” is “1”) and the virtual machine C (information whose “information ID” is “2”) are retractable. Further, the migration order determination unit 113 determines that the virtual machine A (information whose “information ID” is “3”) and the virtual machine F (information whose “information ID” is “4”) are not retractable.

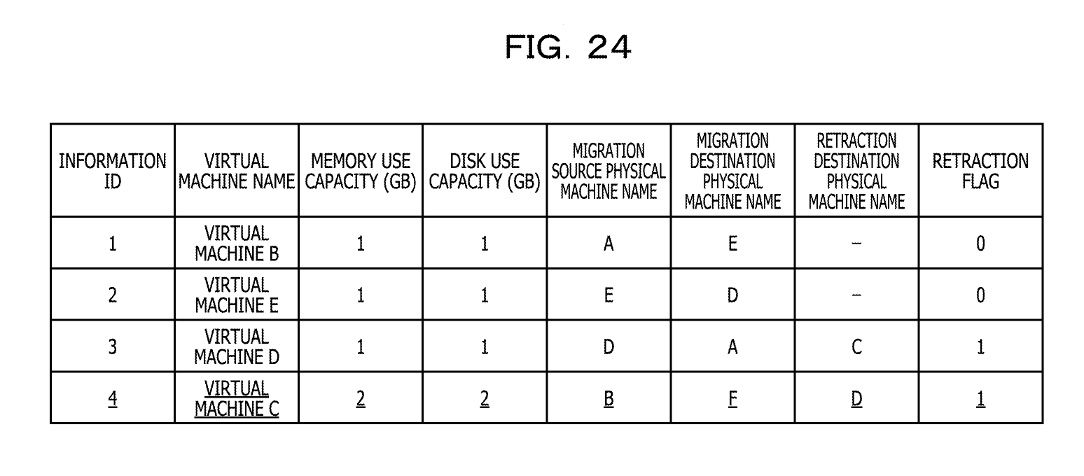

Accordingly, the information management unit 114 stores the information whose “information ID” is “2” in the migration non-completion information 134 illustrated in FIG. 20 as information whose “information ID” is “4” in the migration determination information 133 into the information storage region 130 as indicated by underlined portions in FIG. 24 (S34). In this case, the information management unit 114 sets “D” indicative of the physical machine D into which the virtual machine C has been retracted to “retraction destination physical machine name” of the information whose “information ID” is “4” in the migration determination information 133 and sets “1” to “retraction flag” as indicated by underlined portions in FIG. 24.

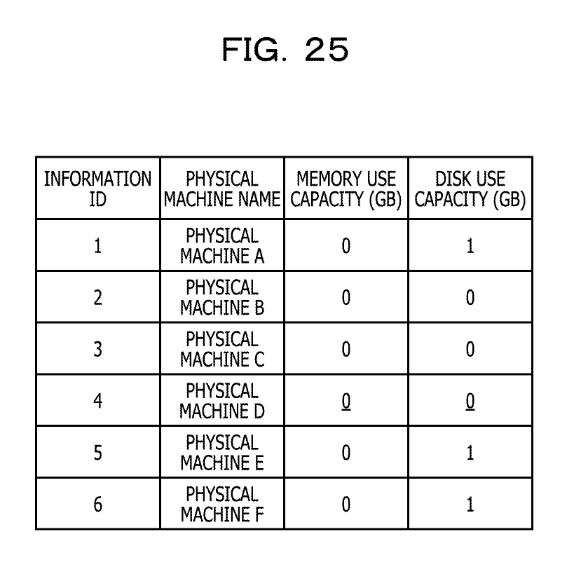

Then, the information management unit 114 updates “2 (GB)” that is the memory free capacity of the physical machine D in the residual physical resource information 135 described hereinabove with reference to FIG. 22 to “0 (GB)” that is a value obtained by subtracting “2 (GB)” that is the memory use capacity of the virtual machine C from the memory free capacity as indicated by an underlined portion in FIG. 25 (S35). Further, the information management unit 114 updates “2 (GB)” that is the disk free capacity of the physical machine D in the residual physical resource information 135 illustrated in FIG. 22 to “0 (GB)” that is a value obtained by subtracting “2 (GB)” that is the disk use capacity of the virtual machine C from the disk free capacity as indicated by an underlined portion in FIG. 25 (S35).

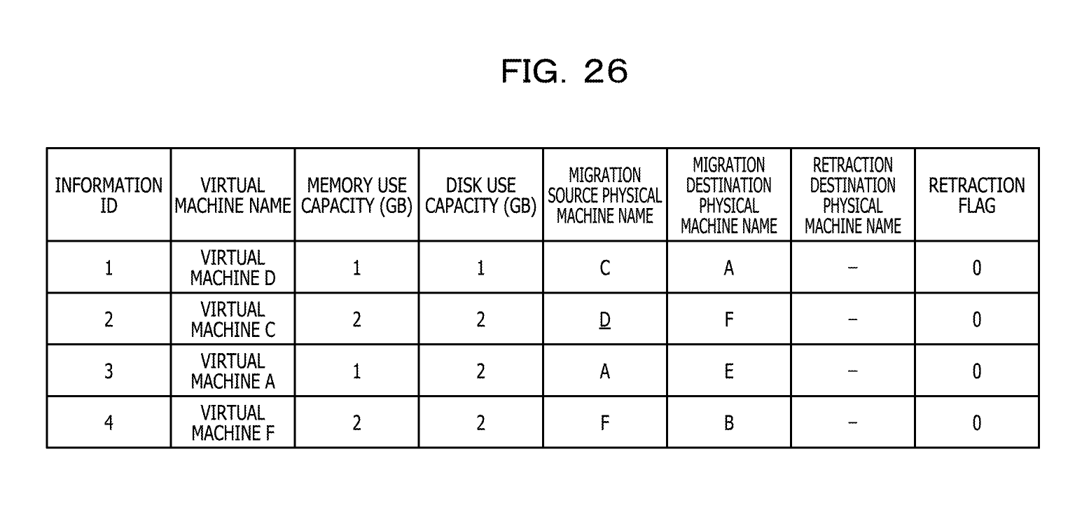

Further, the information management unit 114 updates “migration source physical machine name” of the information whose “information ID” is “2” in the migration non-completion information 134 to “D” indicative of the physical machine D that is the physical machine 2 into which the virtual machine C is to be retracted as indicated by an underlined portion in FIG. 26 (S36).

In particular, if the virtual machine 3 corresponding to the information extracted by the process at step S32 can be retracted into a physical machine 2 other than the physical machine 2 of the migration destination (YES at S33), then the information management unit 114 adds the information of the virtual machine 3 corresponding to the information extracted by the process at step S32 to the migration determination information 133 (S34). On the other hand, in this case, the information management unit 114 does not remove the information of the virtual machine 3 corresponding to the information extracted by the process at step S32 from the migration non-completion information 134 (S35).

This makes it possible for the migration order determination unit 113 to manage the virtual machine 3 corresponding to the information extracted by the process at step S32 as the virtual machine 3 that is to be migrated to the physical machine 2 of the migration destination again after the virtual machine 3 is retracted into a physical machine 2 other than the physical machine 2 of the migration destination.

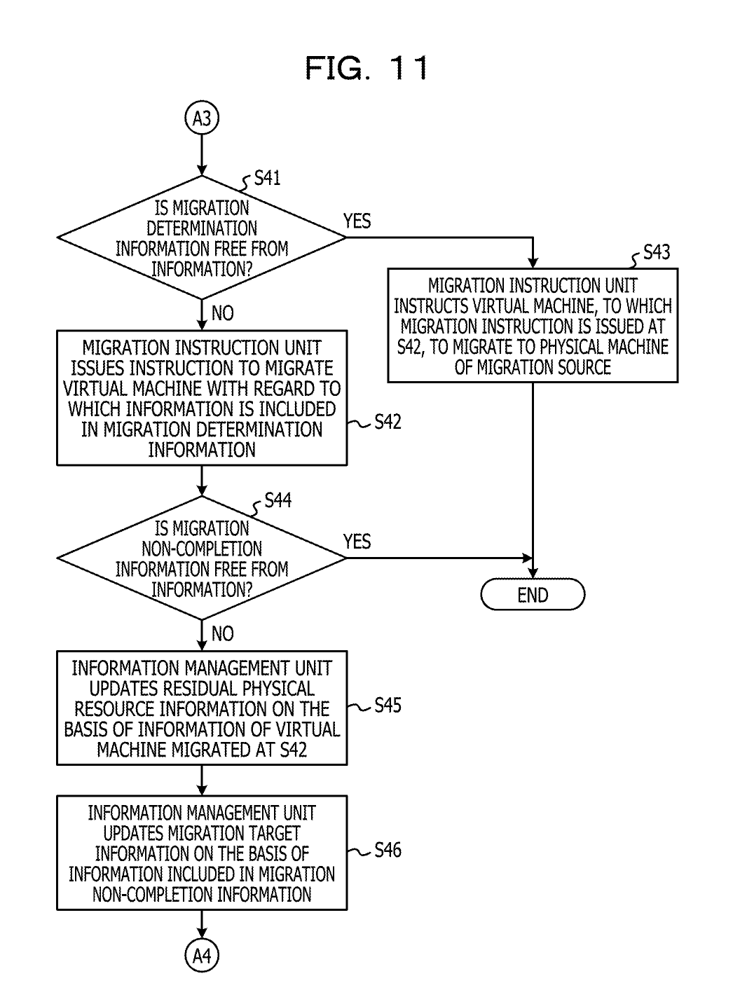

Referring back to FIG. 10, if all information included in the migration non-completion information 134 is extracted already (YES at S31), then the migration order determination unit 113 determines whether the migration determination information 133 is free from information as depicted in FIG. 11, in other words, whether information is included in the migration determination information 133 (S41). If it is determined that the migration determination information 133 is not free from information (NO at S41), namely, that information is included in the migration determination information 133, then the migration instruction unit 115 issues an instruction to migrate the virtual machine 3 with regard to which information is included in the migration determination information 133 (S42). In particular, the migration instruction unit 115 issues an instruction to migrate the virtual machine 3 determined to be migratable to the physical machine 2 of the migration destination by the process at step S23 and to retract the virtual machine 3 determined to be retractable to a physical machine 2 other than the physical machine 2 of the migration destination by the process at step S33.

Then, the migration order determination unit 113 determines whether the migration non-completion information 134 is free from information, in other words, whether information is included in the migration non-completion information 134 (S44). As a result, if it is determined that the migration non-completion information 134 is not free from information (NO at S44), namely, that information is included in the migration non-completion information 134, then the information management unit 114 updates the residual physical resource information 135 on the basis of the information of the virtual machine 3 migrated by the process at step S42 (S45). In particular, when the migration of the virtual machine 3 is completed by the process at step S42, the physical resources of the physical machine 2 of the migration source that has been used by the virtual machine 3 whose migration is completed are released. Therefore, the information management unit 114 updates the residual physical resource information 135 by the process at step S45.

Further, in this case, the information management unit 114 updates the migration target information 131 on the basis of the information included in the migration non-completion information 134 (S46). Then, the migration order determination unit 113 executes the processes at the steps beginning with step S21 (migration virtual machine determination process and retraction virtual machine determination process) again. In particular, if information exists in the migration non-completion information 134 in the process at step S44, then this signifies that the migration of the virtual machines 3 to the physical machines 2 of the respective migration destinations is not completed. Therefore, in this case, the migration order determination unit 113 executes the processes at the steps beginning with step S21 again regarding the information having existed in the migration non-completion information 134 as the migration target information 131.

On the other hand, if the migration determination information 133 is free from information (YES at S41), then the migration instruction unit 115 instructs the virtual machine 3, to which the migration instruction is issued by the process at step S42, to migrate to the physical machine 2 of the migration source (S43). Then, the migration instruction unit 115 ends the migration controlling process. In particular, if it is determined by the process at step S41 that the migration determination information 133 is free from information, then this signifies that any of the virtual machines 3 determined as migratable to the physical machines 2 of the migration destinations and the virtual machines 3 determined as retractable into physical machines 2 other than the physical machines 2 of the migration destinations does not exist. Therefore, in this case, the migration instruction unit 115 determines that it is difficult to implement the placement of the virtual machines 3 calculated by the placement determination unit 111 in a state in which operation of the virtual machines 3 continues. Accordingly, in this case, the migration instruction unit 115 returns the virtual machines 3 to the state before the migration controlling process is started and ends the migration controlling process (abnormal end), for example.

On the other hand, if the migration non-completion information 134 is free from information after an instruction to migrate the virtual machine 3 is issued by the process at step S42 (NO at S41, S42 and YES at S44), then the migration instruction unit 115 ends the migration controlling process. In other words, in this case, the migration instruction unit 115 determines that the migration of all virtual machines 3 to be migrated to the physical machines 2 of the migration destinations is completed and ends the migration controlling process (normal end).

It is to be noted that the processes after it is determined by the process at step S31 that all information is extracted already until the process at step S43 or S46 is performed, namely, until it is determined by the process at step S44 that the migration non-completion information 134 is free from information, are hereinafter referred to also as virtual machine migration process.

[Example of Virtual Machine Migration Process for the First Time]

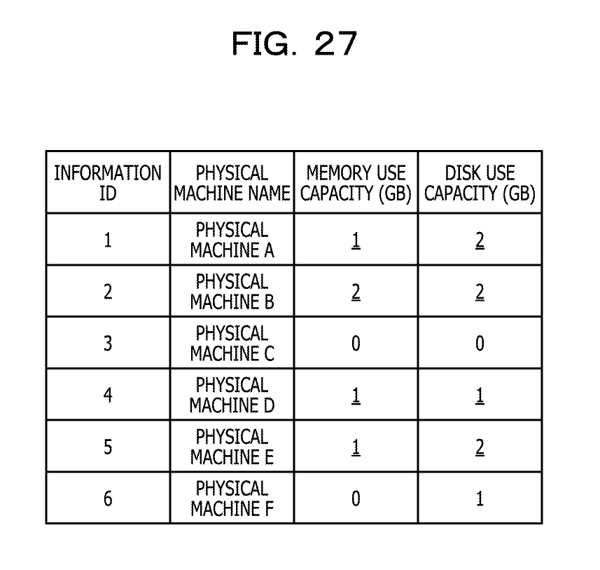

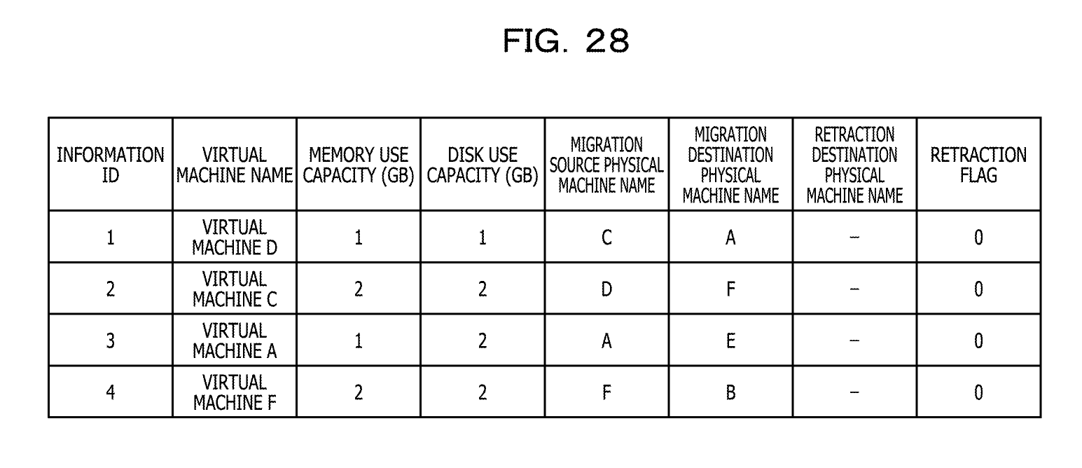

Now, an example of the virtual machine migration process executed for the first time is described. FIGS. 27 and 28 are views illustrating an example of the virtual machine migration process executed for the first time.

Referring back to FIG. 11, the migration instruction unit 115 first performs migration of all information included in the migration determination information 133 depicted in FIG. 24 (information whose “information ID” is “1” to “4”) (S42).

Thereafter, since the migration non-completion information 134 is not free from information (NO at S44) as illustrated in FIG. 26, the migration order determination unit 113 refers to the migration determination information 133 illustrated in FIG. 24. Then, the migration order determination unit 113 acquires information set to “memory use capacity,” “disk use capacity” and “migration source physical machine name” of the virtual machines 3 migrated by the process at step S42. In particular, the migration order determination unit 113 acquires “1 (GB)” as “memory use capacity,” “1 (GB)” as “disk use capacity” and “A (physical machine A)” as “migration source physical machine name” of the virtual machine B from the migration determination information 133 illustrated in FIG. 24. Further, the migration order determination unit 113 acquires “1 (GB)” as “memory use capacity,” “1 (GB)” as “disk use capacity” and “E (physical machine E)” as “migration source physical machine name” of the virtual machine E. Further, the migration order determination unit 113 acquires “1 (GB)” as “memory use capacity,” “1 (GB)” as “disk use capacity” and “D (physical machine D)” as “migration source physical machine name” of the virtual machine D. Furthermore, the migration order determination unit 113 acquires “2 (GB)” as “memory use capacity,” “2 (GB)” as “disk use capacity” and “B (physical machine B)” as “migration source physical machine name” of the virtual machine C.

Then, the information management unit 114 updates the residual physical resource information 135 on the basis of the information acquired from the migration determination information 133 (S45). In particular, the migration order determination unit 113 acquires “0 (GB)” that is a value set to “memory free capacity” of the physical machine A in FIG. 25 and “1 (GB)” that is a value set to “memory use capacity” of the virtual machine A in FIG. 26. Then, the migration order determination unit 113 sets “1 (GB)” that is a value obtained by adding “0 (GB)” and “1 (GB)” to “memory free capacity” of the physical machine A as indicated by an underlined portion in FIG. 27. Further, the migration order determination unit 113 acquires “1 (GB)” that is a value set to “disk free capacity” of the physical machine A in FIG. 25 and “1 (GB)” that is a value set to “disk use capacity” of the virtual machine A in FIG. 26. Then, the migration order determination unit 113 sets “2 (GB)” that is a value obtained by adding “1 (GB)” and “1 (GB)” to “disk free capacity” of the physical machine A as indicated by an underlined portion in FIG. 27. Further, the information management unit 114 updates the residual physical resource information 135 similarly also with regard to the physical machines B, D and E indicated by underlined portions in FIG. 27.

Thereafter, the information management unit 114 creates the information included in the migration non-completion information 134 illustrated in FIG. 26 as new migration target information 131 as illustrated in FIG. 28 (S46).

[Example of Migration Virtual Machine Determination Process for the Second Time]

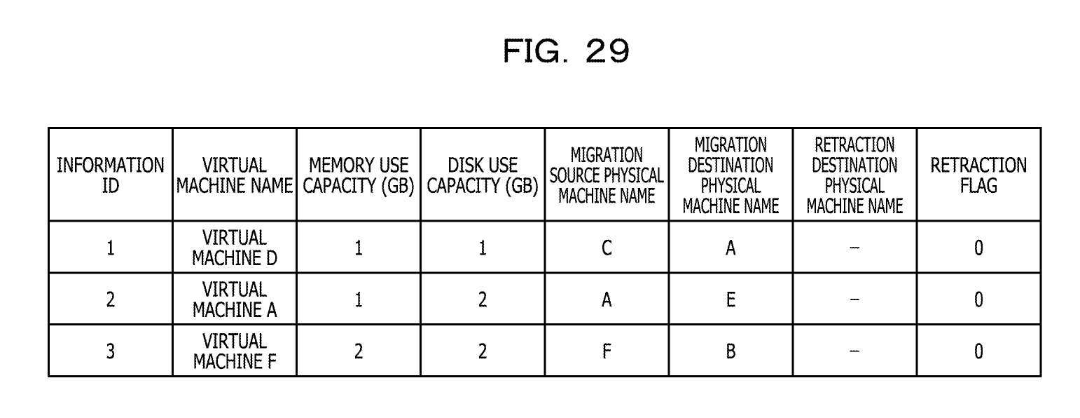

Now, an example of the migration virtual machine determination process executed for the second time is described. FIGS. 29 to 31 are views illustrating an example of the migration virtual machine determination process executed for the second time.

Referring back to FIG. 9, from the migration target information 131 illustrated in FIG. 28, the migration order determination unit 113 first extracts information whose “information ID” is “1” (information whose “virtual machine name” is “virtual machine D”) (S22). Then, the migration order determination unit 113 acquires “1 (GB)” that is information set to “memory use capacity” whose “information ID” is “1” and “1 (GB)” that is information set to “disk use capacity” whose “information ID” is “1.” Furthermore, the migration order determination unit 113 acquires “A (physical machine A)” that is information set to “migration destination physical machine name” whose “information ID” is “1.”

Thereafter, the migration order determination unit 113 refers to the residual physical resource information 135 illustrated in FIG. 27 to acquire “1 (GB)” that is information set to “memory free capacity” and “2 (GB)” that is information set to “disk free capacity” of the information whose information set to “physical machine name” is “physical machine A.”

Here, of the information acquired by the migration order determination unit 113, the memory use capacity and the disk use capacity of the virtual machine D are equal to or smaller than the memory free capacity and the disk free capacity of the physical machine A, respectively. Therefore, the migration order determination unit 113 determines that the virtual machine D that is the virtual machine 3 corresponding to the information extracted by the process at step S22 is migratable to the physical machine A that is the physical machine 2 of the migration destination (YES at S23). Accordingly, the information management unit 114 stores the information extracted by the process at step S22 (information whose “virtual machine name” is “virtual machine D”) as migration determination information 133 into the information storage region 130 (S24).

Further, the information management unit 114 updates “1 (GB)” that is the memory free capacity of the physical machine A of the residual physical resource information 135 illustrated in FIG. 27 to “0 (GB)” that is a value obtained by subtracting “1 (GB)” that is the memory use capacity of the virtual machine D from the memory free capacity (S25). Further, the information management unit 114 updates “2 (GB)” that is the disk free capacity of the physical machine A of the residual physical resource information 135 illustrated in FIG. 27 to “1 (GB)” that is a value obtained by subtracting “1 (GB)” that is the disk use capacity of the virtual machine D from the disk free capacity (S25).

Thereafter, the migration order determination unit 113 repeats execution of the processes at steps S21 to S26 until all information included in the migration target information 131 illustrated in FIG. 28 is extracted already. As a result, the migration order determination unit 113 determines in the process at step S23 that the virtual machine D (information whose “information ID” is “1” in the migration target information 131 illustrated in FIG. 28) and the virtual machine A (information whose “information ID” is “3” in the migration target information 131 illustrated in FIG. 28) are migratable. Further, the migration order determination unit 113 determines in the process at step S23 that the virtual machine F (information whose “information ID” is “4” in the migration target information 131 illustrated in FIG. 28) is migratable. Further, the migration order determination unit 113 determines in the process at step S23 that the virtual machine C (information whose “information ID” is “2” in the migration target information 131 illustrated in FIG. 28) is not migratable.

Accordingly, the information management unit 114 stores the information whose “information ID” is “1,” “3” and “4” from within the migration target information 131 of FIG. 28 as migration determination information 133 into the information storage region 130 as illustrated in FIG. 29 (S24).

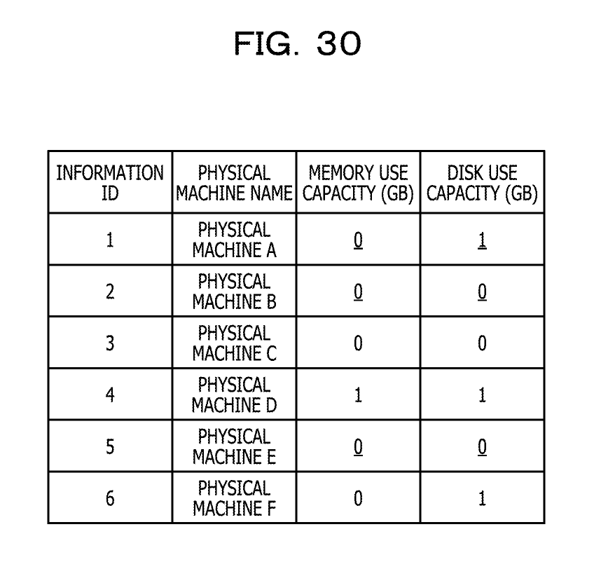

Further, the information management unit 114 updates “1 (GB)” that is the memory free capacity of the physical machine A in the residual physical resource information 135 illustrated in FIG. 27 to “0 (GB)” that is a value obtained by subtracting “1 (GB)” that is the memory use capacity of the virtual machine D from the memory free capacity as indicated by an underlined portion in FIG. 30 (S25). Further, the information management unit 114 updates “2 (GB)” that is the disk free capacity of the physical machine A in the residual physical resource information 135 illustrated in FIG. 27 to “1 (GB)” that is a value obtained by subtracting “1 (GB)” that is the disk use capacity of the virtual machine D from the disk free capacity as indicated by an underlined portion in FIG. 30. Similarly, the information management unit 114 updates “2 (GB)” that is the memory free capacity of the physical machine B in the residual physical resource information 135 illustrated in FIG. 27 to “0 (GB)” and updates “2 (GB)” that is the disk free capacity of the physical machine B to “0 (GB)” as indicated by underlined portions in FIG. 30. Further, the information management unit 114 updates “1 (GB)” that is the memory free capacity of the physical machine E in the residual physical resource information 135 illustrated in FIG. 27 to “0 (GB)” and updates “2 (GB)” that is the disk free capacity of the physical machine E to “0 (GB)” as indicated by underlined portions in FIG. 30 (S25).

Further, the information management unit 114 stores the information whose “information ID” is “2” from within the migration target information 131 of FIG. 28 as migration non-completion information 134 into the information storage region 130 (S26).

[Example of Retraction Virtual Machine Determination Process for the Second Time]

In the following, an example of the retraction virtual machine determination process executed for the second time is described.

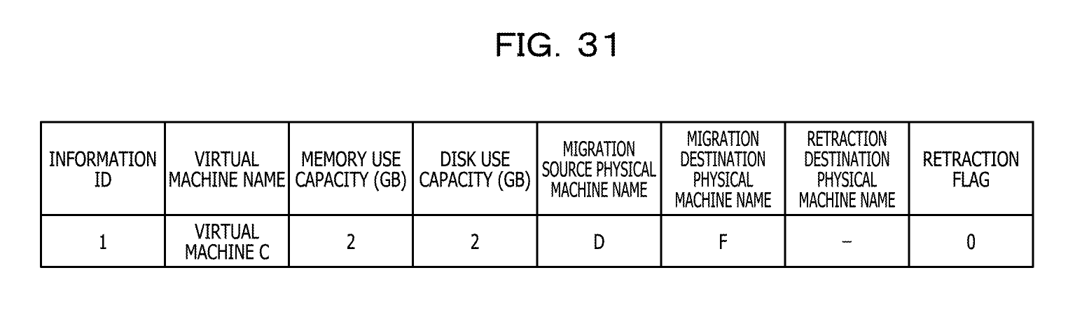

Referring back to FIG. 10, from the migration non-completion information 134 illustrated in FIG. 31, the migration order determination unit 113 first extracts information whose “information ID” is “1” (information whose “virtual machine name” is “virtual machine C”) (S32). Then, the migration order determination unit 113 acquires “2 (GB)” that is information set to “memory use capacity” whose “information ID” is “1” and “2 (GB)” that is information set to “disk use capacity” whose “information ID” is “1.”

Further, the migration order determination unit 113 refers to the residual physical resource information 135 illustrated in FIG. 30 to specify a physical machine 2 into which the virtual machine C from which the acquisition of information has been performed can be retracted.

Here, the physical machines A, B, C and E (the physical machines 2 other than the physical machine 2 of the migration source of the virtual machine C and physical machine 2 of the migration destination of the virtual machine C) are free from a physical machine 2 into which the virtual machine C can be retracted. Therefore, the migration order determination unit 113 determines that the virtual machine C that is a virtual machine 3 corresponding to the information extracted at step S32 is not retractable into the physical machine C that is a physical machine 2 other than the physical machine 2 of the migration destination (NO at S33). Then, since all information included in the migration non-completion information 134 illustrated in FIG. 31 is extracted already, the migration order determination unit 113 executes the processes at the steps beginning with step S41 (YES at S31).

[Example of Virtual Machine Migration Process for the Second Time]

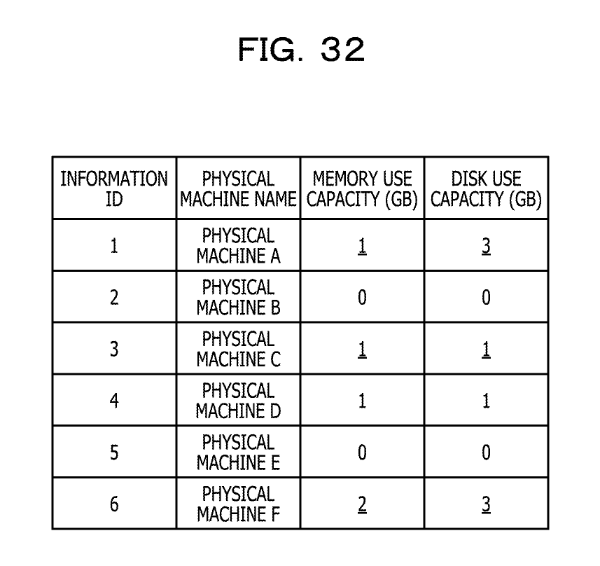

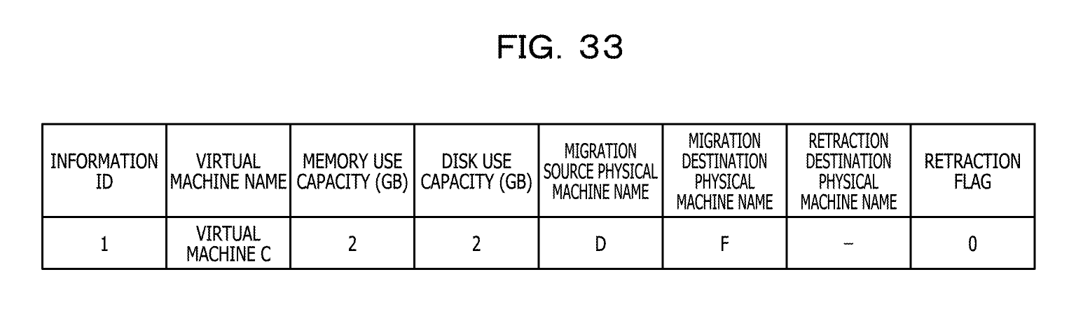

In the following, an example of the virtual machine migration process executed for the second time is described. FIGS. 32 and 33 are views illustrating an example of the virtual machine migration process executed for the second time.

Referring back to FIG. 11, the migration order determination unit 113 first performs migration of all information included in the migration determination information 133 illustrated in FIG. 29 (information whose “information ID” is “1” to “3”) (S42).

Thereafter, since the migration non-completion information 134 is not free from information (NO at S44), namely, since information exists in the migration non-completion information 134, as depicted in FIG. 31, the migration order determination unit 113 refers to the migration determination information 133 illustrated in FIG. 29. Then, the migration order determination unit 113 acquires information set to “memory use capacity,” “disk use capacity” and “migration source physical machine name” of the virtual machine 3 migrated by the process at step S42. In particular, the migration order determination unit 113 acquires “1 (GB)” as “memory use capacity”, “1 (GB)” as “disk use capacity” and “C (physical machine C)” as “migration source physical machine name” of the virtual machine D from the migration determination information 133 illustrated in FIG. 29. Further, the migration order determination unit 113 acquires “1 (GB)” as “memory use capacity”, “2 (GB)” as “disk use capacity” and “A (physical machine A)” as “migration source physical machine name” of the physical machine A. Furthermore, the migration order determination unit 113 acquires “2 (GB)” as “memory use capacity”, “2 (GB)” as “disk use capacity” and “F (physical machine F)” as “migration source physical machine name” of the virtual machine F.

Then, the information management unit 114 updates the residual physical resource information 135 on the basis of the information acquired from the migration determination information 133 (S45). In particular, the migration order determination unit 113 acquires “0 (GB)” that is a value set to “memory free capacity” of the physical machine C in FIG. 30 and “1 (GB)” that is a value set to “memory use capacity” of the virtual machine D in FIG. 29. Then, the migration order determination unit 113 sets “1 (GB)” that is a value obtained by adding “0 (GB)” and “1 (GB)” to “disk free capacity” of the physical machine C as indicated by an underlined portion in FIG. 32. Further, the migration order determination unit 113 acquires “0 (GB)” that is a value set to “disk free capacity” of the physical machine C in FIG. 30 and “1 (GB)” that is a value set to “disk use capacity” of the virtual machine D in FIG. 29. Then, the migration order determination unit 113 sets “1 (GB)” that is a value obtained by adding “0 (GB)” and “1 (GB)” to “disk free capacity” of the physical machine C as indicted by an underlined portion in FIG. 32. Then, the information management unit 114 similarly updates the residual physical resource information 135 also with regard to the information corresponding to the physical machines A and F as indicated by underlined portions in FIG. 32.

Thereafter, the information management unit 114 creates information included in the migration non-completion information 134 depicted in FIG. 31 as new migration target information 131 as illustrated in FIG. 33 (S46).

[Example of Migration Virtual Machine Determination Process for the Third Time]

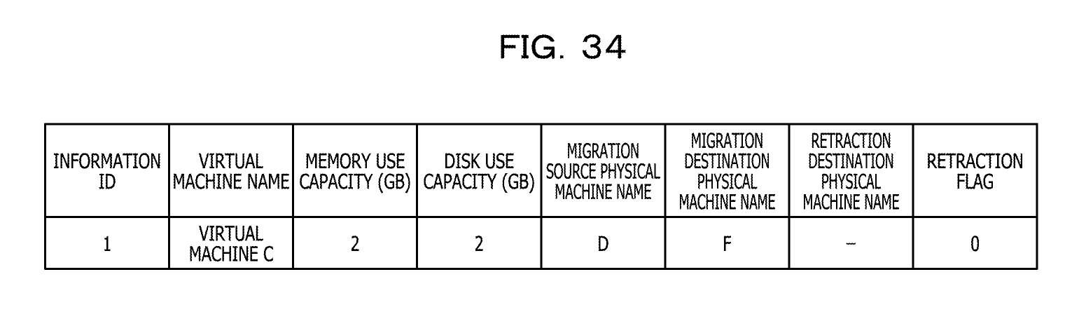

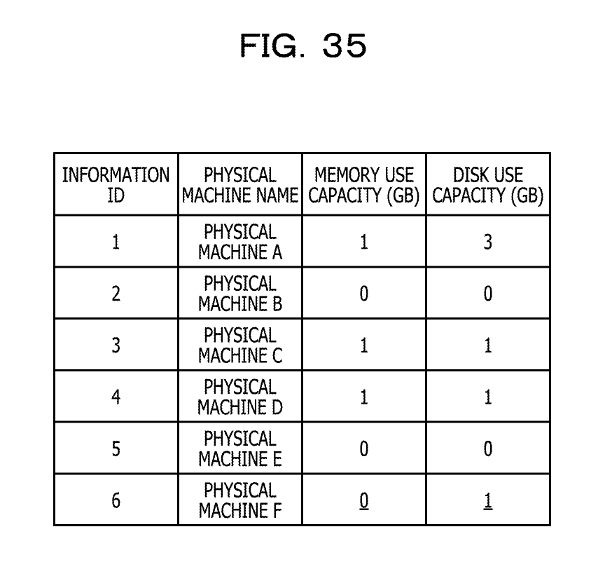

In the following, an example of the migration virtual machine determination process executed for the third time is described. FIGS. 34 and 35 are views illustrating an example of the migration virtual machine determination process executed for the third time.

Referring back to FIG. 9, from the migration target information 131 illustrated in FIG. 33, the migration order determination unit 113 first extracts information whose “information ID” is “1” (information whose “virtual machine name” is “virtual machine C”) (S22). Then, the migration order determination unit 113 acquires “2 (GB)” that is information set to “memory use capacity” whose “information ID” is “1” and “2 (GB)” that is information set to “disk use capacity” whose “information ID” is “1.” Further, the migration order determination unit 113 acquires “F (physical machine F)” that is information set to “migration destination physical machine name” whose “information ID” is “1.”

Thereafter, the migration order determination unit 113 refers to the residual physical resource information 135 illustrated in FIG. 32 to acquire “2 (GB)” that is information set to “memory free capacity” and “3 (GB)” that is information set to “disk free capacity” of the information in which the information set to “physical machine name” is “physical machine F.”

Here, of the information acquired by the migration order determination unit 113, the memory use capacity and the disk use capacity of the virtual machine C are equal to or smaller than the memory free capacity and the disk free capacity of the physical machine F, respectively. Therefore, the migration order determination unit 113 determines that the virtual machine C that is the virtual machine 3 corresponding to the information extracted by the process at step S22 is migratable to the physical machine F that is the physical machine 2 of the migration destination (YES at S23).

Accordingly, the information management unit 114 stores the information extracted at step S22 (information whose “virtual machine name” is “virtual machine C”) as migration determination information 133 into the information storage region 130 as illustrated in FIG. 34 (S24). Further, the information management unit 114 updates the memory free capacity of the physical machine F in the residual physical resource information 135 illustrated in FIG. 32 from “2 (GB)” to “0 (GB)” that is a value obtained by subtracting “2 (GB)” that is the memory use capacity of the virtual machine C from the memory free capacity as indicated by an underlined portion in FIG. 35 (S25). Furthermore, the information management unit 114 updates the disk free capacity of the physical machine F in the residual physical resource information 135 illustrated in FIG. 32 from “3 (GB)” to “1 (GB)” that is a value obtained by subtracting “2 (GB)” that is the disk use capacity of the virtual machine C from the disk free capacity as indicated by an underlined portion in FIG. 35 (S25).

Here, all information included in the migration target information 131 illustrated in FIG. 33 is extracted already (YES at S21). Further, the migration order determination unit 113 stores all information included in the migration target information 131 illustrated in FIG. 33 as the migration determination information 133 into the information storage region 130 as illustrated in FIG. 34, the migration non-completion information 134 is free from information (YES at S31). Therefore, the migration order determination unit 113 executes the processes at the steps beginning with step S41 (virtual machine migration process).

[Example of Virtual Machine Migration Process for the Third Time]

Now, an example of the virtual machine migration process executed for the third time is described.

Referring back to FIG. 11, the migration instruction unit 115 first performs migration of all information included in the migration determination information 133 illustrated in FIG. 34 (information whose “information ID” is “1”) (S42).

Here, the migration non-completion information 134 is free from information (YES at S44). Therefore, the migration instruction unit 115 determines that all of the virtual machines 3 to be migrated to the physical machines 2 of the migration destinations are migrated to the physical machines 2 of the respective migration destinations. Accordingly, the migration instruction unit 115 ends the migration controlling process (normal end).

In this manner, the information processing apparatus 1 acquires the migration target information 131 including information that associates, for each virtual machine 3, information of the virtual machine 3, information of a physical machine 2 of the migration source of the virtual machine 3 and information of a physical machine 2 of the migration destination of the virtual machine 3 with one another. Further, the information processing apparatus 1 acquires the first state information 132a indicative of states of the plurality of physical machines 2 and the plurality of virtual machines 3. Thereafter, the information processing apparatus 1 instructs the virtual machines 3, which are migratable to the physical machines 2 of the migration destinations from among the plurality of the virtual machines 3, to migrate to the physical machines 2 of the respective migration destinations on the basis of the migration target information 131 and the first state information 132a.

Then, the information processing apparatus 1 issues, to the virtual machines 3 retractable into physical machines 2 other than the physical machines 2 of the migration destinations from among the virtual machines 3 to which a migration instruction to a physical machine 2 of a migration destination is not issued, a retraction instruction to physical machines 2 other than the physical machines 2 of the migration destinations. Thereafter, the information processing apparatus 1 acquires, for each of the plurality of physical machines 2 and the plurality of virtual machines 3 after the retraction of the virtual machines 3, the second state information 132b for determining whether or not migration of a virtual machine 3 is permitted. Further, the information processing apparatus 1 issues an instruction to the virtual machines 3 migratable to the physical machines 2 of the migration destinations from among the virtual machines 3, to which a migration instruction to a physical machine 2 of an migration destination is not issued, to migrate to the physical machines 2 of the migration destinations on the basis of the migration target information 131 and the second state information 132b.

In particular, the information processing apparatus 1 successively performs migration to a physical machine 2 of the migration destination while performing retraction of a virtual machine 3 on the basis of the migration target information 131 and the state information 132. Consequently, for example, even when it is difficult to migrate the plurality of virtual machines 3 simultaneously, the information processing apparatus 1 can perform relocation of the virtual machines 3 such that the optimum placement of the virtual machines 3 calculated by the manager is implemented.

[Migration Controlling Process According to Second Embodiment]

Now, a migration controlling process according to a second embodiment is described.

In the process at step S42 in the first embodiment, the migration instruction unit 115 performs migration of a virtual machine 3 to a physical machine 2 of the migration destination before it is determined whether the migration controlling process normally ends or abnormally ends (YES at S41 or YES at S44). This makes it possible for the migration instruction unit 115 to reduce time taken for the migration of all virtual machines 3.

In contrast, the migration instruction unit 115 in the second embodiment does not perform the process at step S42 but performs migration of a virtual machine 3 to a physical machine 2 of the migration destination after it is determined that the migration controlling process ends normally (after determination of YES is performed in the process at step S44). Consequently, when the migration controlling process ends abnormally, the migration instruction unit 115 may not perform a process (S43) for instructing the virtual machine 3, to which a migration instruction to a physical machine 2 of the migration destination is issued by the process at step S42, to migrate to the physical machine 2 of the migration source. Therefore, it is possible for the manager to reduce the processing burden on the information processing apparatus 1 when the migration controlling process ends abnormally. In the following, the migration controlling process according the second embodiment is described.

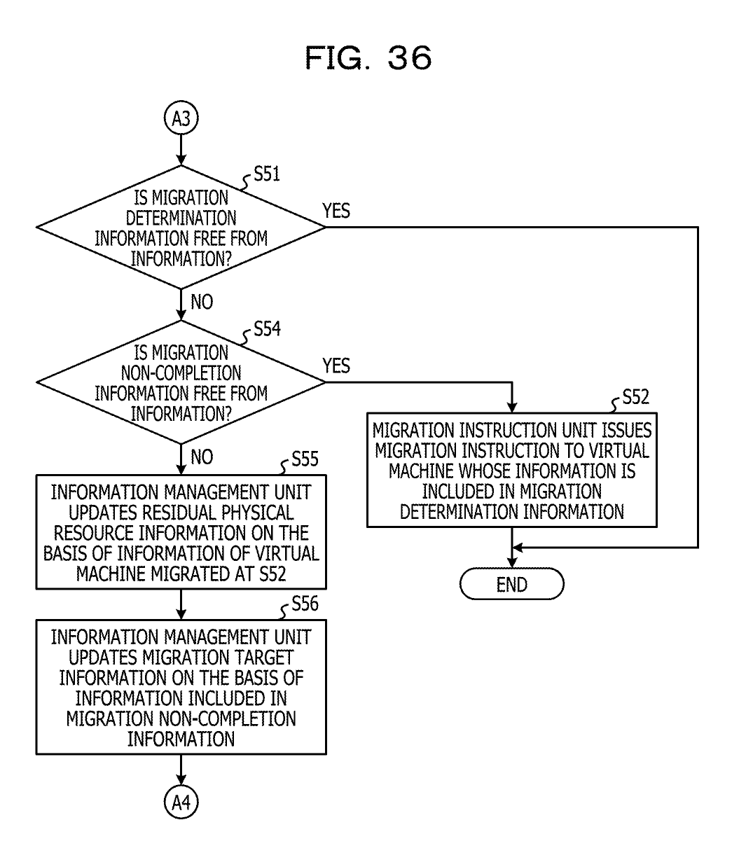

FIG. 36 is a flow chart illustrating details of the migration controlling process in the second embodiment. It is to be noted that FIG. 36 is a view corresponding to FIG. 11 in the first embodiment. Therefore, description is given only of processes having contents different from those of the processes described hereinabove with reference to FIG. 11.

As depicted in FIG. 36, the migration instruction unit 115 issues a migration instruction to a virtual machine 3 whose information is included in the migration determination information 133 when the migration determination information 133 is not free from information and the migration non-completion information 134 is free from information (NO at S51, YES at S54, and S52). Further, even where the migration determination information 133 is free from information, the migration instruction unit 115 does not perform a process corresponding to the process at step S43 (YES at S51).

This makes it possible for the manager to reduce the processing burden on the information processing apparatus 1 when the migration controlling process ends abnormally.

[Migration Controlling Process According to Third Embodiment]

In the following, a migration controlling process according to a third embodiment is described.

In the process at step S33 in the first embodiment, the migration order determination unit 113 determines whether or not a virtual machine 3 corresponding to information extracted by the process at step S32 is retractable into a physical machine 2 other than the physical machine 2 of the migration destination. Then, when the virtual machine 3 is retractable, the migration instruction unit 115 issues an instruction to retract the virtual machine 3 corresponding to the information extracted by the process at step S32 (S34 and S42). In other words, the migration order determination unit 113 in the first embodiment performs retraction of all retractable virtual machines 3 irrespective of whether or not the retraction is demanded to end the migration controlling process.

In contrast, the migration order determination unit 113 in the third embodiment performs only retraction demanded to normally end the migration control process. This makes it possible for the migration order determination unit 113 to suppress the number of times of retraction of a virtual machine 3, which is performed until the migration controlling process normally ends. Therefore, the migration order determination unit 113 is allowed to perform the migration controlling process efficiently. In the following, the migration controlling process in the third embodiment is described.

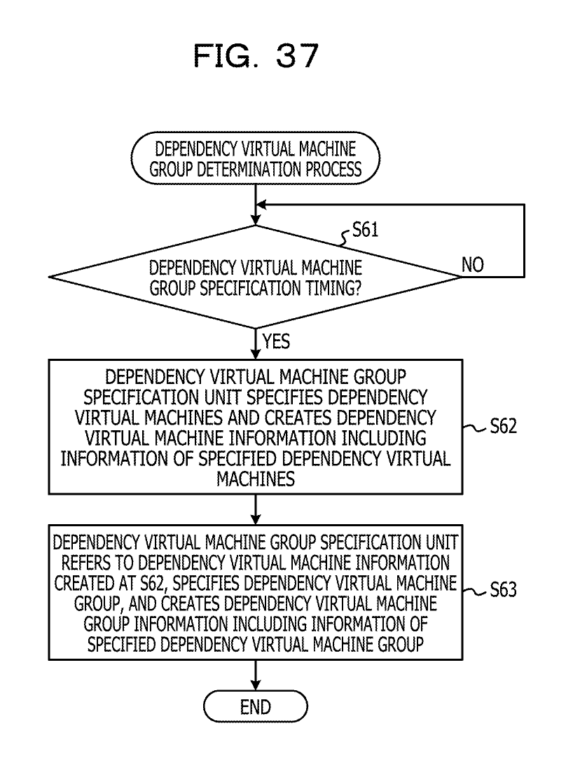

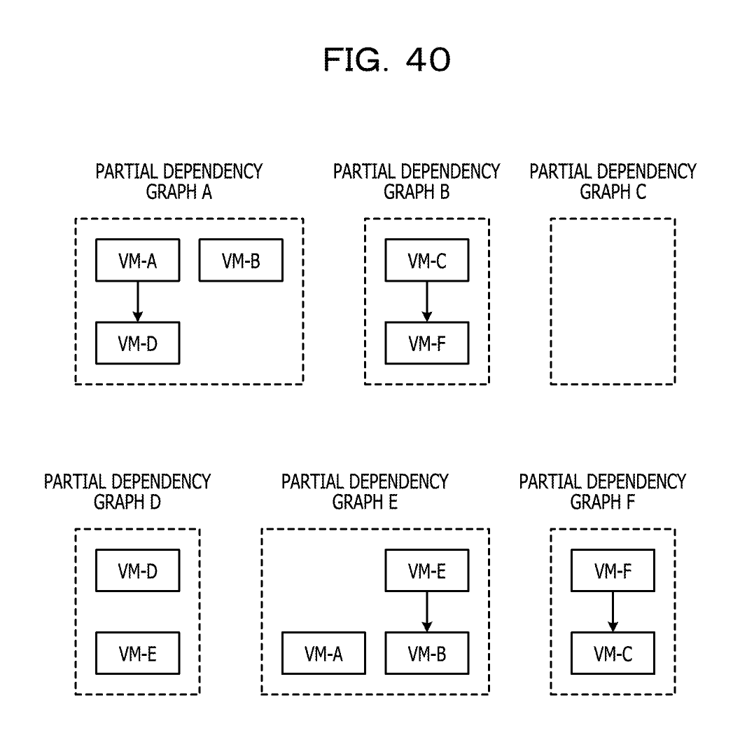

FIGS. 37 to 39 are flow charts illustrating details of the migration controlling process in the third embodiment. Further, FIGS. 40 to 55 are views illustrating details of the migration controlling process in the third embodiment. The migration controlling process in the third embodiment is described with reference to FIGS. 40 to 55.

[Dependency Virtual Machine Group Determination Process]

First, a process for creating the dependency virtual machine group information 137 (hereinafter referred to also as dependency virtual machine group determination process) from within the migration controlling process in the third embodiment is described.

In FIG. 37, the dependency virtual machine group specification unit 116 waits till a dependency virtual machine group specification timing (NO at S61). The dependency virtual machine group specification timing may be a timing before a retraction virtual machine determination process is performed. In other words, the dependency virtual machine group determination process may be executed at a timing before the retraction virtual machine determination process is performed every time the retraction virtual machine determination process is performed. When a dependency virtual machine group specification timing comes thereafter (YES at S61), the dependency virtual machine group specification unit 116 creates dependency virtual machine information 136 (S62). In the following, an example of the dependency virtual machine information 136 is described.

[Example of Dependency Virtual Machine Information]

First, a dependency graph used upon creation of the dependency virtual machine information 136 is described. The dependency graph is a graph illustrating a relationship (hereinafter referred to also as dependency relationship) between virtual machines 3 to be migrated to physical machines 2 of migration destinations and dependency virtual machines 31 of the virtual machines 3. In particular, when to create a dependency graph, the dependency virtual machine group specification unit 116 creates a partial dependency graph that is a dependency graph for each physical machine 2 configuring the information processing system 10. In the following, an example of partial dependency graphs is described. It is to be noted that, in the following description, the virtual machines 3A, 3B, 3C, 3D, 3E and 3F are referred to as VM-A, VM-B, VM-C, VM-D, VM-E and VM-F, respectively. Further, in the following description, partial dependency graphs of the physical machines 2A, 2B, 2C, 2D, 2E and 2F are referred to also as partial dependency graphs A, B, C, D, E and F, respectively.

FIG. 40 depicts an example of partial dependency graphs. The partial dependency graphs depicted in FIG. 40 are partial dependency graphs that indicate dependency relationships when the virtual machines 3 depicted in FIG. 2 are migrated in such a manner as depicted in FIG. 3.

In particular, in the example depicted in FIG. 2, the virtual machine 3A and the virtual machine 3B are deployed in the physical machine 2A. Further, the free capacity of the memory of the physical machine 2E that is a physical machine 2 of the migration destination of the virtual machine 3A and the virtual machine 3B is “1 (GB),” and the free capacity of the disk of the physical machine 2E is “2 (GB).” Further, the use capacity of the memory of the virtual machine 3A is “1 (GB)” and the use capacity of the disk of the virtual machine 3A is “2 (GB),” and the use capacity of the memory of the virtual machine 3B is “1 (GB)” and the use capacity of the disk of the virtual machine 3B is “1 (GB).” Therefore, in the example illustrated in FIG. 2, only one virtual machine 3 from between the virtual machine 3A and the virtual machine 3B is migratable into the physical machine 2E. Thus, in order to make it possible for both of the virtual machine 3A and the virtual machine 3B to be migrated into the physical machine 2E, the virtual machine 3E deployed in the physical machine 2E is to be migrated previously into the physical machine 2D that is a physical machine 2 of the migration destination. In other words, in this case, one of the virtual machine 3A and the virtual machine 3B has a dependency relationship to the virtual machine 3E.

Therefore, the dependency virtual machine group specification unit 116 sets, for example, VM-E to an upper stage portion, which indicates the virtual machine 3 deployed in each physical machine 2, as indicated by the partial dependency graph E of FIG. 40. Further, the dependency virtual machine group specification unit 116 sets VM-A and VM-B to a lower stage portion, which indicates the virtual machine 3 deployed in each physical machine 2 after migration of each virtual machine 3 is performed. Then, the dependency virtual machine group specification unit 116 sets, for example, an arrow mark indicating that the VM-B that is one virtual machine 3 from between the VM-A and VM-B has a dependency relationship to the VM-E (arrow mark extending from the VM-E to the VM-B). It is to be noted that only one virtual machine 3 from between the VM-A and the VM-B has the dependency relationship to the VM-E. Therefore, in the example illustrated in FIG. 40, the dependency virtual machine group specification unit 116 does not set an arrow mark extending from the VM-E to the VM-A.

Further, in the example illustrated in FIG. 3, the virtual machine 3E is deployed in the physical machine 2E. Further, the free capacity of the memory of the physical machine 2D that is a physical machine 2 of the migration destination of the virtual machine 3E is “3 (GB),” and the free capacity of the disk of the physical machine 2D is “3 (GB).” Meanwhile, the use capacity of the memory of the virtual machine 3E is “1 (GB)” and the use capacity of the disk of the virtual machine 3E is “1 (GB).” Accordingly, in the example depicted in FIG. 2, the virtual machine 3E is in a state migratable into the physical machine 2 without waiting migration of any other virtual machine 3. In other words, the virtual machine 3E in this case is in a state in which the virtual machine 3E does not have a dependency relationship to any other virtual machine 3.

Therefore, the dependency virtual machine group specification unit 116 sets, for example, VM-D to the upper stage and sets VM-E to the lower stage as indicated by the partial dependency graph D of FIG. 40. Further, the VM-E does not have a dependency relationship to the VM-D. Therefore, the dependency virtual machine group specification unit 116 does not set an arrow mark extending from the VM-D to the VM-E. Description of the other partial dependency graphs depicted in FIG. 40 is omitted herein. In the following, an example when a dependency graph is created using the partial dependency graphs described above with reference to FIG. 40 is described.

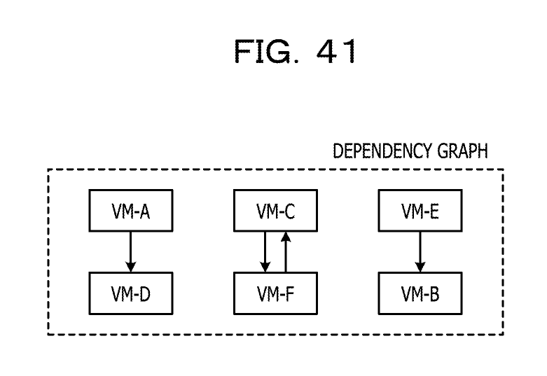

FIG. 41 depicts an example of the dependency graph. The dependency virtual machine group specification unit 116 creates a dependency graph by integrating the arrow marks included in the partial dependency graphs described hereinabove with reference to FIG. 40 as depicted in FIG. 41. In particular, the dependency virtual machine group specification unit 116 creates a dependency graph by setting only one virtual machine 3 for each dependency relationship and setting arrow marks included in the partial dependency graphs described hereinabove with reference to FIG. 40.

In particular, in the dependency graph depicted in FIG. 41, the VM-D has a dependency relationship to the VM-A, and the VM-B has a dependency relationship to the VM-E. Further, in the dependency graph depicted in FIG. 41, the VM-C has a dependency relationship to the VM-F and the VM-F has a dependency relationship to the VM-C. In other words, in the dependency graph depicted in FIG. 41, the VM-C and the VM-F have a relationship that one of the virtual machines 3 is a dependency virtual machine 31 of the other virtual machine 3 (this is hereinafter referred to also as circulation of dependency relationship). This is a state in which, unless at least one of the virtual machines 3 of the VM-C and the VM-F is retracted into a physical machine 2 other than the physical machine 2 in which the virtual machine 3 is deployed at present (physical machine 2 of the migration source) and the physical machine 2 of the migration destination, any of the VM-C and the VM-F is not migratable to the physical machines 2 of the respective migration destinations. Accordingly, at least one of the virtual machines 3 of the VM-C and the VM-F is to be retracted into a physical machine 2 other than the physical machine 2 in which the virtual machine 3 is deployed at present and the physical machine 2 of the migration destination in order to normally end the migration controlling process.

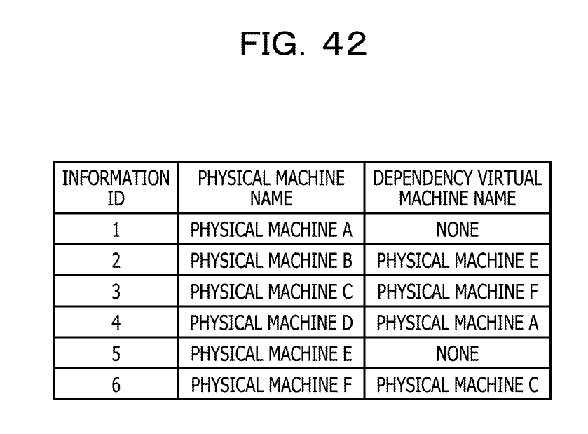

Now, an example of the dependency virtual machine information 136 is described. FIG. 42 is a view illustrating an example of the dependency virtual machine information 136. The dependency virtual machine information 136 illustrated in FIG. 42 includes, as items, “information ID” for identifying each piece of information included in the dependency virtual machine information 136, and “virtual machine name” for identifying the virtual machines 3. Further, the dependency virtual machine information 136 illustrated in FIG. 42 includes, as an item, “dependency virtual machine name” for identifying a dependency virtual machine 31 to which each virtual machine 3 has a dependency relationship.

In particular, contents of the dependency virtual machine information 136 illustrated in FIG. 42 correspond to the contents of the dependency graph described hereinabove with reference to FIG. 41. In particular, in the dependency virtual machine information 136 illustrated in FIG. 42, “dependency virtual machine name” of the information whose “virtual machine name” is “virtual machine B” (information whose “information ID” is “2”) is “virtual machine E.” Further, in the dependency virtual machine information 136 illustrated in FIG. 42, “dependency virtual machine name” of the information whose “virtual machine name” is “virtual machine C” (information whose “information ID” is “3”) is “virtual machine F.” Meanwhile, in the dependency virtual machine information 136 illustrated in FIG. 42, in “dependency virtual machine name” of the information whose “virtual machine name” is “virtual machine A” (information whose “information ID” is “1”), “none” is set. Description of the other information in FIG. 42 is omitted herein.

Referring back to FIG. 37, the dependency virtual machine group specification unit 116 creates the dependency virtual machine group information 137 that is information of the dependency virtual machine group 32 by referring to the dependency virtual machine information 136 created by the process at step S62 (S63). In the following, an example of the dependency virtual machine group information 137 is described.

[Example of Dependency Virtual Machine Group Information]

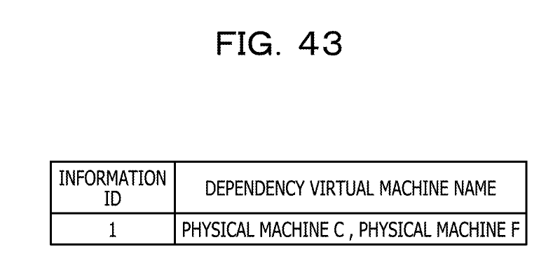

FIG. 43 is a view illustrating an example of the dependency virtual machine group information 137. The dependency virtual machine group information 137 illustrated in FIG. 43 includes, as items, “information ID” for identifying each piece of information included in the dependency virtual machine group information 137 and “dependency virtual machine name” for identifying a dependency virtual machine 31 included in each dependency virtual machine group 32.

In the dependency graph described hereinabove with reference to FIG. 41 or in the dependency virtual machine information 136 described hereinabove with reference to FIG. 42, the dependency virtual machines 31 having a circulating dependency relationship are the virtual machine C and the virtual machine F. Therefore, the dependency virtual machine group specification unit 116 specifies the virtual machine C and the virtual machine F as dependency virtual machines 31 that configure the dependency virtual machine group 32. Accordingly, the dependency virtual machine group specification unit 116 sets “virtual machine C, virtual machine F” to “dependency virtual machine name” of the information whose “information ID” is “1” as indicated by the dependency virtual machine group information 137 of FIG. 43.

This makes it possible for the dependency virtual machine group specification unit 116 to specify and manage the dependency virtual machine group 32 at least including a dependency virtual machine 31 that is to be retracted in order to end the migration controlling process.

[Migration Controlling Process According to Third Embodiment]

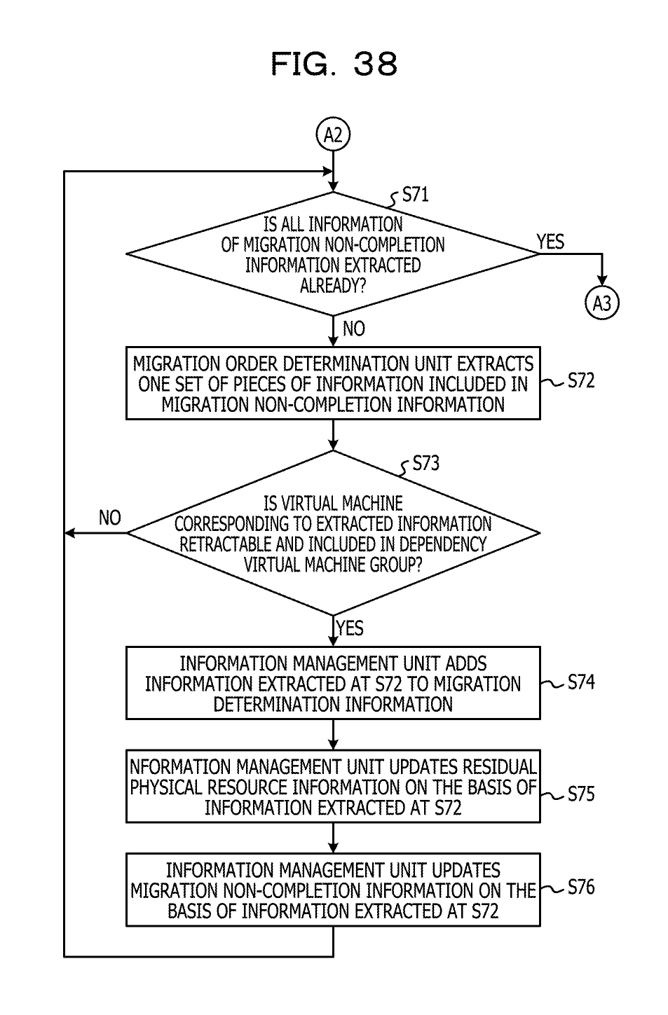

Now, details of the migration controlling process according to the third embodiment are described. FIG. 38 is a flow chart illustrating details of the migration controlling process according to the third embodiment. In particular, FIG. 38 is a view corresponding to the retraction virtual machine determination process (FIG. 10) in the first embodiment. It is to be noted that, in the flow chart depicted in FIG. 38, the processes at steps S71, S72 and S74 to S76 have contents same as those of the processes at steps S31, S32 and S34 to S36 described hereinabove with reference to FIG. 10, respectively. Therefore, detailed description of the processes at steps S71, S72 and S74 to S76 is omitted herein.

As depicted in FIG. 38, the migration order determination unit 113 in the third embodiment determines whether or not the virtual machine 3 corresponding to the information extracted by the process at step S72 is a retractable virtual machine 3 and besides is a virtual machine 3 included in the dependency virtual machine group 32 specified by the process at step S63 in FIG. 37 (S73). As a result, if it is determined that the virtual machine 3 is a retractable virtual machine 3 and is included in the dependency virtual machine group 32 (YES at S73), then the migration order determination unit 113 performs the processes at the steps beginning with step S74 similarly as in the case of the first embodiment. On the other hand, although the virtual machine 3 is a retractable virtual machine 3, if the virtual machine 3 is not included in the dependency virtual machine group 32 (NO at S73), then the processes at the steps beginning with step S71 are executed repetitively.

This makes it possible for the migration order determination unit 113 to suppress the number of times of retraction of a virtual machine 3 to be performed before the migration controlling process is ended. Therefore, the migration order determination unit 113 in this case can efficiently perform the migration controlling process.

It is to be noted that, in the following description, the dependency virtual machine group determination process is described assuming that the dependency virtual machine group information 137 described hereinabove with reference to FIG. 43 is created before the retraction virtual machine determination process is performed for the first time.

[Example of Retraction Virtual Machine Determination Process and Virtual Machine Migration Process for the First Time]

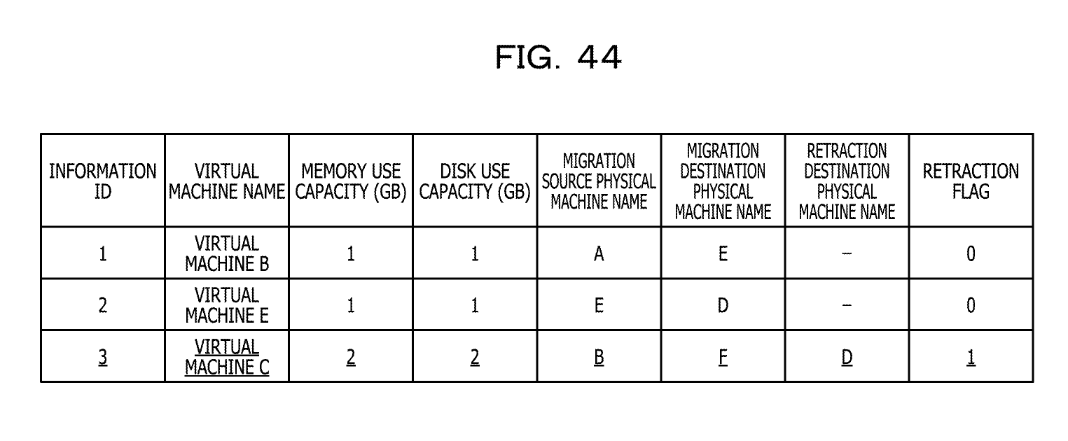

Now, an example of the retraction virtual machine determination process and the virtual machine migration process executed for the first time is described. FIGS. 44 to 47 are views illustrating an example of the retraction virtual machine determination process and the virtual machine migration process executed for the first time. It is to be noted that, in the following description, an example of the retraction virtual machine determination process and the virtual machine migration process executed after the migration virtual machine determination process to be executed for the first time is executed is described.

Referring back to FIG. 38, from the migration non-completion information 134 illustrated in FIG. 20, the migration order determination unit 113 first extracts information whose “information ID” is “1” (information whose “virtual machine name” is “virtual machine D”) (S72).

Then, the migration order determination unit 113 acquires “1 (GB)” that is information set to “memory use capacity” whose “information ID” is “1” and “1 (GB)” that is information set to “disk use capacity” whose “information ID” is “1.” Further, the migration order determination unit 113 refers to the residual physical resource information 135 illustrated in FIG. 19 to specify a physical machine 2 into which the virtual machine D whose information is acquired can be retracted. In particular, in the residual physical resource information 135 illustrated in FIG. 19, “memory free capacity” and “disk free capacity,” for example, of the information whose “information ID” is “3” (information whose “physical machine name” is “physical machine C”) are “1 (GB)” and “1 (GB),” respectively. Therefore, the memory use capacity and the disk use capacity of the virtual machine D are equal to or smaller than the memory free capacity and the disk free capacity of the physical machine C, respectively.

Here, the migration order determination unit 113 in the third embodiment refers to the dependency virtual machine group information 137 described hereinabove with reference to FIG. 43 to determine whether or not “virtual machine D” is set in “dependency virtual machine name” (S73). In particular, the migration order determination unit 113 determines whether or not the virtual machine D is a virtual machine 3 included in the dependency virtual machine group 32.

In “dependency virtual machine name” of the dependency virtual machine group information 137 illustrated in FIG. 43, “virtual machine D” is not set. Therefore, the migration order determination unit 113 determines not to perform retraction of the virtual machine D that is the virtual machine 3 corresponding to the information extracted by the process at step S72 (NO at S73). In particular, in this case, the migration order determination unit 113 determines that retraction of the virtual machine D may not be performed in order to end the migration controlling process. This makes it possible for the migration order determination unit 113 to suppress the number of times of retraction of a virtual machine 3 to be performed in order to end the migration controlling process.

Then, the migration order determination unit 113 extracts information whose “information ID” is “2” (information whose “virtual machine name” is “virtual machine C”) in the migration non-completion information 134 illustrated in FIG. 20 (S72).

Then, the migration order determination unit 113 acquires “2 (GB)” that is information set to “memory use capacity” whose “information ID” is “2” and “2 (GB)” that is information set to “disk use capacity” whose “information ID” is “2.” Further, the migration order determination unit 113 refers to the residual physical resource information 135 illustrated in FIG. 19 to specify a physical machine 2 into which the virtual machine C whose information is acquired can be retracted. In particular, in the residual physical resource information 135 illustrated in FIG. 19, “memory free capacity” and “disk free capacity” of the information whose “information ID” is “4” (information whose “physical machine name” is “physical machine D”) are “2 (GB)” and “2 (GB),” respectively. Therefore, the memory use capacity and the disk use capacity of the virtual machine C are equal to or smaller than the memory free capacity and the disk free capacity of the physical machine D, respectively.

Here, the migration order determination unit 113 refers to the dependency virtual machine group information 137 illustrated in FIG. 43 to determine whether or not “virtual machine C” is set in “dependency virtual machine name.” In particular, the migration order determination unit 113 determines whether or not the virtual machine C is a virtual machine 3 included in the dependency virtual machine group 32.

In “dependency virtual machine name” of the dependency virtual machine group information 137 illustrated in FIG. 43, “virtual machine C” is set. Therefore, the migration order determination unit 113 determines to perform retraction of the virtual machine C that is the virtual machine 3 corresponding to the information extracted by the process at step S72 (YES at S73).

Thereafter, the information management unit 114 stores the information extracted at step S72 (information whose “virtual machine name” is “virtual machine C”) as migration determination information 133 into the information storage region 130 as indicated by an underlined portion in FIG. 44 (S74). In particular, the migration order determination unit 113 sets the information whose “information ID” is “2” in the migration non-completion information 134 illustrated in FIG. 20 as information whose “information ID” is “3” in the migration determination information 133 as indicated by an underlined portion in FIG. 44.

Here, the migration order determination unit 113 sets “D” indicative of the physical machine D, into which retraction of the virtual machine C has been performed, to “retraction destination physical machine name” of the information whose “information ID” is “3” in the migration determination information 133 as indicated by an underlined portion in FIG. 44 similarly as in the case of the first embodiment. This makes it possible for the migration order determination unit 113 to appropriately manage the information of the physical machine 2 that acts as migration source when the virtual machine C after retracted is to be migrated to the physical machine 2 of the migration destination. Further, the migration order determination unit 113 sets “1” to “retraction flag” as indicated by an underlined portion in FIG. 44 similarly as in the case of the first embodiment. This makes it possible for the migration order determination unit 113 to specify, when the process at step 73 is to be executed again, the virtual machine 3 retracted already into a physical machine 2 other than the physical machine 2 of the migration destination (virtual machine 3 determined already so as to be retracted).

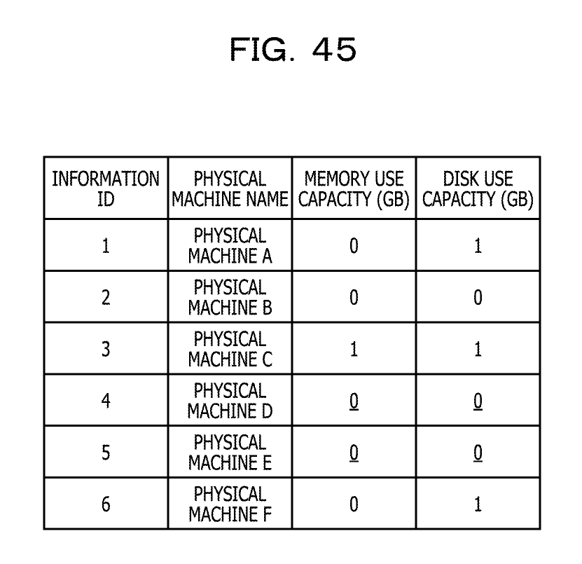

Further, the information management unit 114 updates “2 (GB)” that is the memory free capacity of the physical machine D in the residual physical resource information 135 illustrated in FIG. 19 to “0 (GB)” that is a value obtained by subtracting “2 (GB)” that is the memory use capacity of the virtual machine C from the memory free capacity as indicated by an underlined portion in FIG. 45 (S75). Then, the information management unit 114 updates “2 (GB)” that is the disk free capacity of the physical machine D in the residual physical resource information 135 illustrated in FIG. 19 to “0 (GB)” that is a value obtained by subtracting “2 (GB)” that is the disk use capacity of the virtual machine C from the disk free capacity as indicated by an underlined portion in FIG. 45 (S75).

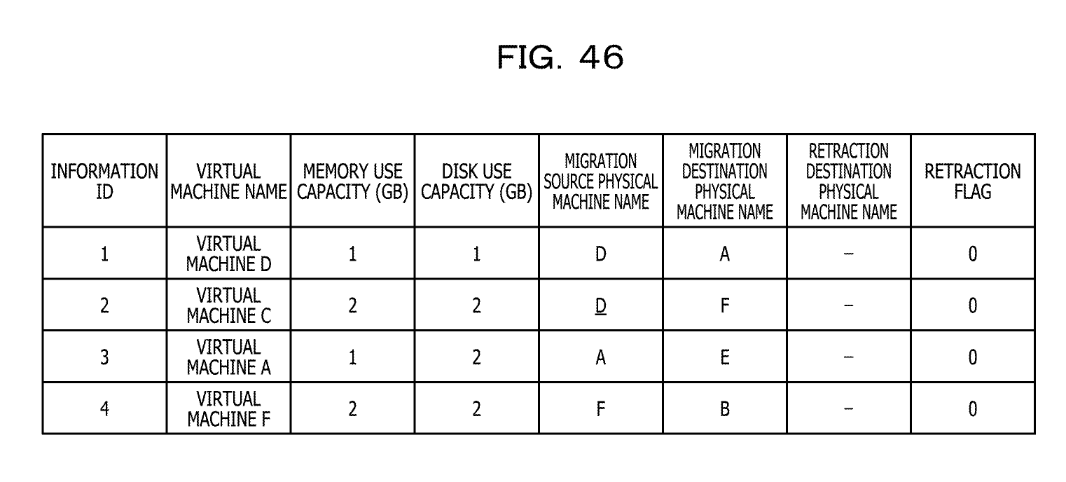

Further, the information management unit 114 updates the information set to “migration source physical machine name” of the virtual machine C to the physical machine D that is the physical machine 2 into which the virtual machine C is to be retracted. This makes it possible for the information management unit 114 to reflect the state of the virtual machine C by retraction of the virtual machine C upon the migration non-completion information 134 as indicated by an underlined portion in FIG. 46 similarly as in the case of the first embodiment.

Thereafter, the migration order determination unit 113 repeats execution of the processes at steps S71 to S76 until all information included in the migration non-completion information 134 illustrated in FIG. 20 is extracted already. As a result, the migration order determination unit 113 determines by the process at step S73 that retraction of the virtual machine A (information whose “information ID” is “3”) and the virtual machine F (information whose “information ID” is “4”) is not performed (NO at S73).

It is to be noted that, in the dependency virtual machine group information 137 illustrated in FIG. 43, “virtual machine C, virtual machine F” is set in “dependency virtual machine name” of the information whose “information ID” is “1.” On the other hand, in the migration determination information 133 illustrated in FIG. 44, retraction of the virtual machine C is determined already. Here, the circulation of the dependency relationship of the virtual machine C and the virtual machine F is resolved by the execution of the retraction of the virtual machine C. Therefore, after the retraction of the virtual machine C is determined, retraction of the virtual machine F may not be performed any more. Accordingly, the migration order determination unit 113 may determine, on the basis of the determination of the retraction, for example, of the virtual machine C, that retraction of the virtual machine F is not performed (NO at S73).

Further, the migration order determination unit 113 may refer, in the process at step S73, for example, to the dependency virtual machine information 136 described hereinabove with reference to FIG. 42, to preferentially retract the virtual machine 3 having a greater number of dependency virtual machines 31 from between the virtual machine C and the virtual machine F. This makes it possible for the migration order determination unit 113 to efficiently perform the migration controlling process.

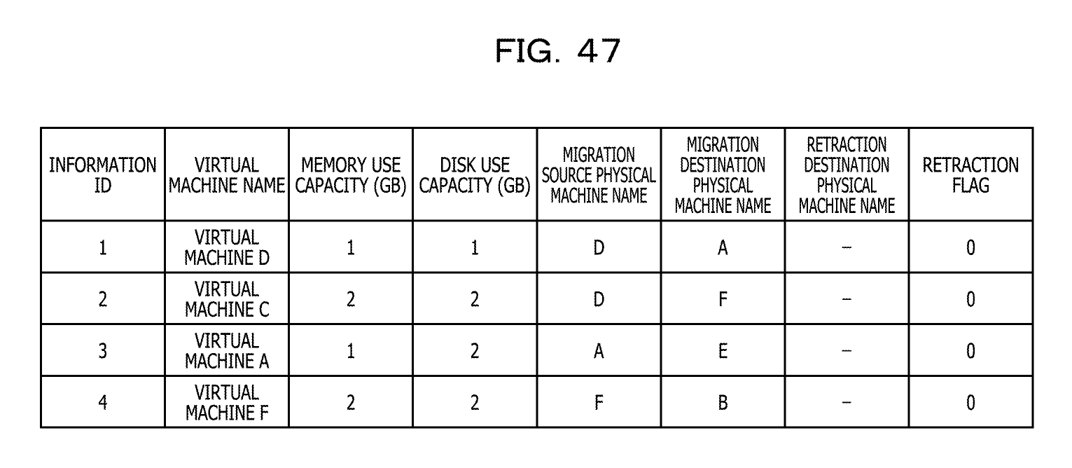

Thereafter, the information management unit 114 updates the migration target information 131 as depicted in FIG. 47 on the basis of the information included in the migration non-completion information 134 described hereinabove with reference to FIG. 46 (S46).

[Example of Dependency Virtual Machine Group Determination Process for the Second Time]

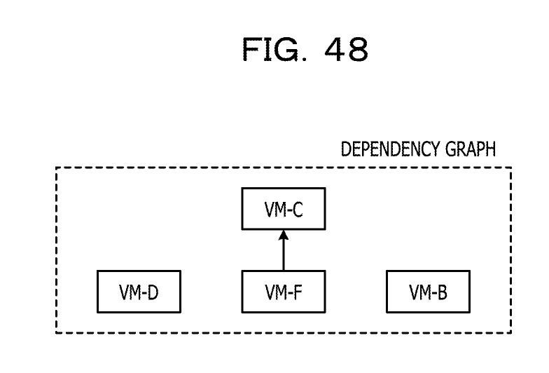

Now, an example of the dependency virtual machine group determination process executed for the second time (dependency virtual machine group determination process executed before the retraction virtual machine determination process for the second time) is described. FIGS. 48 to 50 are views illustrating an example of the dependency virtual machine group determination process executed for the second time.

FIG. 48 is an example of a dependency graph created by the dependency virtual machine group determination process executed for the second time. In particular, in the dependency graph depicted in FIG. 48, the VM-C has a dependency relationship to the VM-F. In addition, in the dependency graph depicted in FIG. 48, no circulation of a dependency relationship occurs. In other words, each virtual machine 3 depicted in FIG. 48 may not be retracted into any physical machine 2 other than the physical machine 2 in which the virtual machine 3 is deployed at present (physical machine 2 of the migration source) and the physical machine 2 of the migration destination in order to end the migration controlling process. It is to be noted that, since the VM-A and the VM-E are virtual machines 3 migrated already to the physical machines 2 of the respective migration destinations, the VM-A and the VM-E are not set in the dependency graph depicted in FIG. 48.

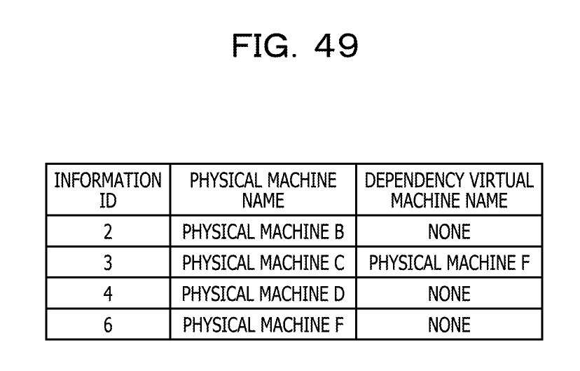

Now, an example of the dependency virtual machine information 136 is described. FIG. 49 is a view illustrating an example of the dependency virtual machine information 136 created by the dependency virtual machine group determination process executed for the second time. It is to be noted that, since the VM-A and the VM-E are virtual machines 3 migrated already to the physical machines 2 of the migration destinations, the VM-A and the VM-E are not set in the dependency virtual machine information 136 illustrated in FIG. 49.

In particular, in the dependency virtual machine information 136 illustrated in FIG. 49, “dependency virtual machine name” of the information whose “virtual machine name” is “virtual machine C” (information whose “information ID” is “3”) is “virtual machine F.” Further, in “dependency virtual machine name” of the other information, “none” indicating that no dependency virtual machine 31 exists is set. It is to be noted that, in the dependency graph depicted in FIG. 48, no dependency relationship exists. Therefore, in this case, the dependency virtual machine group specification unit 116 does not create the dependency virtual machine group information 137.

Referring back to FIG. 11, then, the migration instruction unit 115 instructs the virtual machine D, virtual machine A and virtual machine F to migrate to the physical machines 2 of the respective migration destinations similarly as in the first embodiment (S42). In particular, in this case, the migration instruction unit 115 migrates the virtual machines 3, in which no dependency virtual machine 31 exists in the dependency virtual machine information 136 illustrated in FIG. 49, to the physical machine 2 of the migration destination.

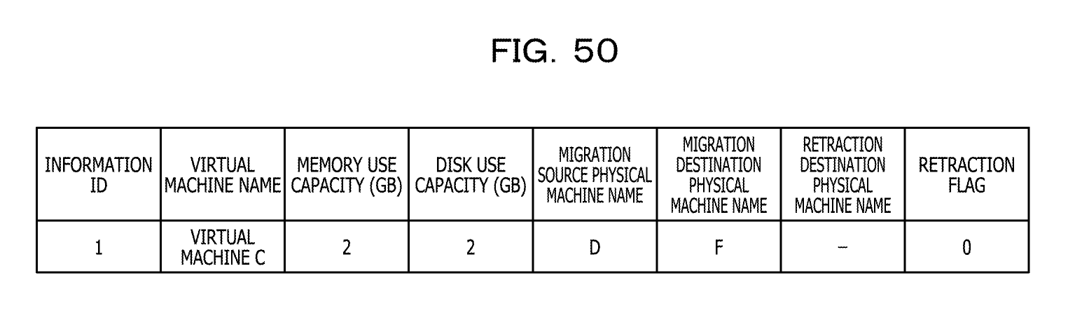

Thereafter, the information management unit 114 updates the migration target information 131 as depicted in FIG. 50 (S46).

[Example of Dependency Virtual Machine Group Determination Process for the Third Time]

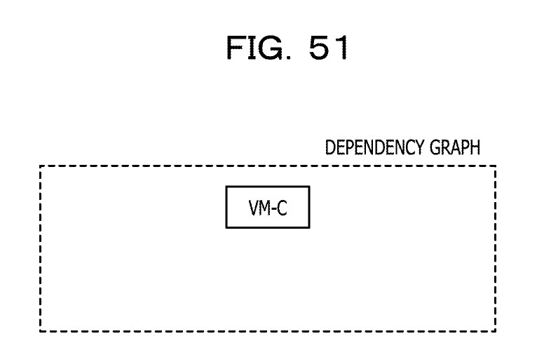

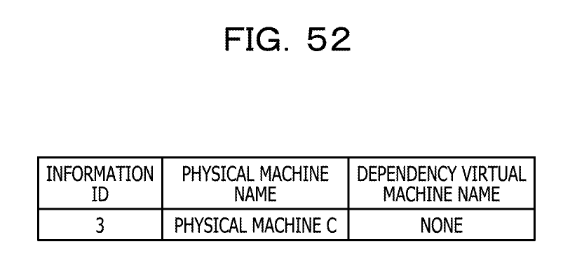

Now, an example of the dependency virtual machine group determination process executed for the third time (dependency virtual machine group determination process executed before the retraction virtual machine determination process for the third time) is described. FIGS. 51 and 52 are views illustrating an example of the dependency virtual machine group determination process executed for the third time.

FIG. 51 is an example of a dependency graph created by the dependency virtual machine group determination process executed for the third time. In particular, in the dependency graph depicted in FIG. 51, since only the VM-C exists, no dependency relationship exists.

Next, an example of the dependency virtual machine information 136 is described. FIG. 52 is a view illustrating an example of the dependency virtual machine information 136 created by the dependency virtual machine group determination process executed for the third time.

In particular, in the dependency virtual machine information 136 illustrated in FIG. 52, “none” is set in “dependency virtual machine name” of the information whose “virtual machine name” is “virtual machine C” (information whose “information ID” is “3”). Further, in the dependency graph depicted in FIG. 51, no dependency relationship exists. Therefore, the dependency virtual machine group specification unit 116 does not create the dependency virtual machine group information 137.

Referring back to FIG. 11, then, the migration instruction unit 115 instructs the virtual machine C to migrate to the physical machine 2 of the migration destination similarly as in the first embodiment (S42). In particular, in this case, the migration instruction unit 115 migrates the virtual machine 3 in which no dependency virtual machine 31 exists in the dependency virtual machine information 136 illustrated in FIG. 52 to the physical machine 2 of the migration destination. Consequently, the migration instruction unit 115 can normally end the migration controlling process (YES at S44).

[Details of Process at Step S62]

Now, details of the process at step S62 in FIG. 37 are described. When the dependency virtual machine group specification unit 116 specifies a dependency virtual machine 31, there sometimes exist a plurality of combinations of virtual machines 3 that can be specified as dependency virtual machines 31.

In this case, the dependency virtual machine group specification unit 116 may specify a combination of virtual machines 3 in which the number of times by which a retraction virtual machine determination process and a migration virtual machine determination process of a virtual machine 3 are performed is smallest as dependency virtual machines 31 before the migration controlling process normally ends. This makes it possible for the dependency virtual machine group specification unit 116 to perform the migration controlling process efficiently. In the following, details of the process at step S62 are described.

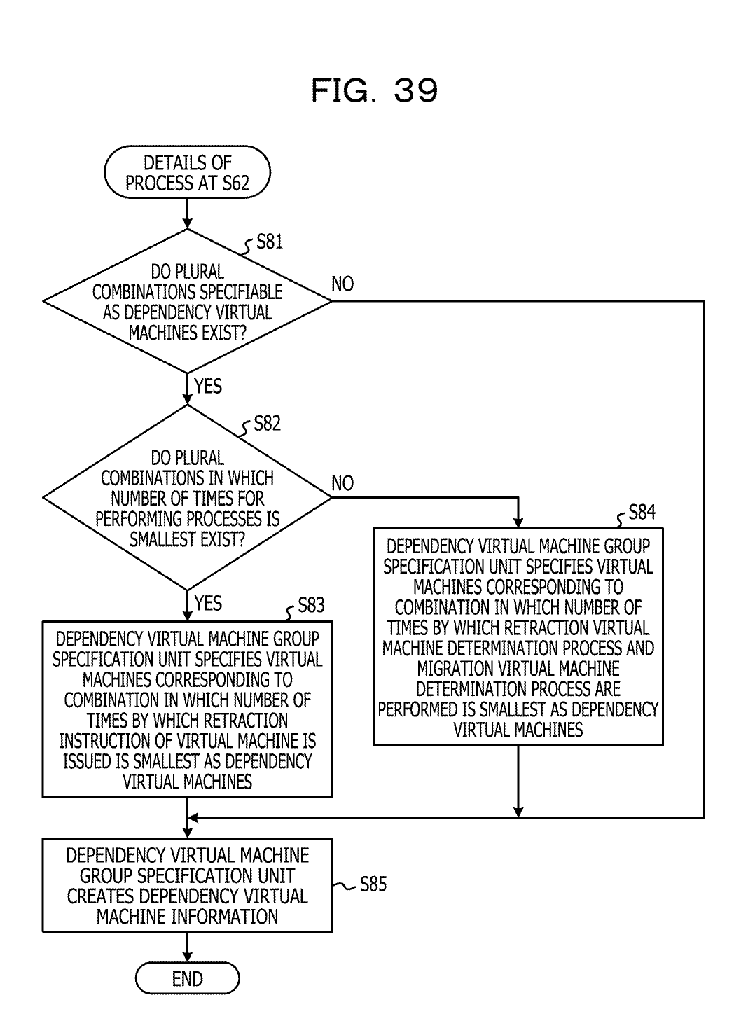

First, the dependency virtual machine group specification unit 116 determines whether or not there exist a plurality of combinations of virtual machines 3 each specifiable as dependency virtual machine 31 as illustrated in FIG. 39 (S81). Then, if a plurality of combinations exist (YES at S81), then the dependency virtual machine group specification unit 116 determines whether or not there exist a plurality of combinations of virtual machines 3 in which the number of times by which the retraction virtual machine determination process and the migration virtual machine determination process are performed is smallest before the migration controlling process ends normally (S82).

If it is determined that there exist a plurality of combinations which exhibit the least number of times by which the processes are performed (YES at S82), then the dependency virtual machine group specification unit 116 specifies the virtual machines 3 corresponding to the combination in which the number of times by which a retraction instruction of a virtual machine 3 is issued is smallest as dependency virtual machines 31 (S83). In particular, the dependency virtual machine group specification unit 116 specifies, for example, the virtual machines 3 corresponding to the combination in which the number of times by which a retraction instruction of a virtual machine 3 is issued is smallest as the dependency virtual machines 31 before the migration controlling process ends normally.

On the other hand, if there do not exist a plurality of combinations in which the number of times by which the processes are performed is smallest (NO at S82), then the dependency virtual machine group specification unit 116 specifies the virtual machines 3 corresponding to the combination in which the number of times by which the retraction virtual machine determination process and the migration virtual machine determination process are performed is smallest as the dependency virtual machines 31 (S84). In particular, the dependency virtual machine group specification unit 116 specifies the virtual machines 3 corresponding to the combination in which the number of times by which the retraction virtual machine determination process and the migration virtual machine determination process are performed is smallest as the dependency virtual machines 31, for example, before the migration controlling process ends normally.

Then, the dependency virtual machine group specification unit 116 creates dependency virtual machine information 136 including the information of the dependency virtual machines 31 specified by the process at step S83 or S84 (S85).

It is to be noted that, where there exist a plurality of combinations in which the number of times by which a retraction instruction is issued is smallest, the dependency virtual machine group specification unit 116 may, for example, select an arbitrary combination from among the plurality of existing combinations and specify the virtual machines 3 corresponding to the selected combination as the dependency virtual machines 31.

[Example of Case in which Plural Combinations of Virtual Machines Specifiable as Dependency Virtual Machines Exist]

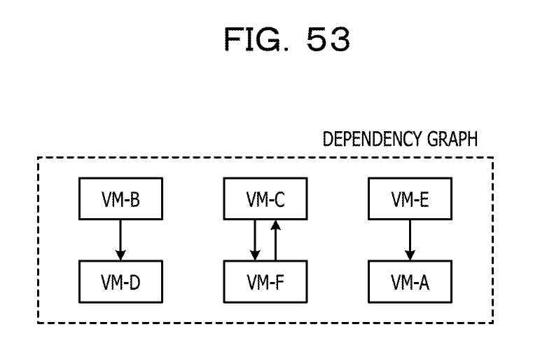

Now, an example in which there exist a plurality of combinations of virtual machines 3 specifiable as dependency virtual machines 31 is described. FIGS. 53 to 55 are views illustrating an example of a case in which there exist a plurality of combinations of virtual machines 3 specifiable as dependency virtual machines 31.

In the partial dependency graph E depicted in FIG. 40, the VM-B has a dependency relationship to the VM-E. Here, the state of the virtual machines 3 depicted in FIG. 2 is such that only one of the virtual machine 3A and the virtual machine 3B has a dependency relationship to the virtual machine 3E. Therefore, it is possible for the dependency virtual machine group specification unit 116 also to create the partial dependency graph E such that the VM-A has a dependency relationship to the VM-E.

Further, in the partial dependency graph A depicted in FIG. 40, the VM-D has a dependency relationship to the VM-A. Here, the state of the virtual machines 3 depicted in FIG. 3 is such that the virtual machine 3D has a dependency relationship to one of the virtual machine 3A and the virtual machine 3B. Therefore, it is possible for the dependency virtual machine group specification unit 116 also to create the partial dependency graph A such that the VM-D has a dependency relationship to the VM-B.

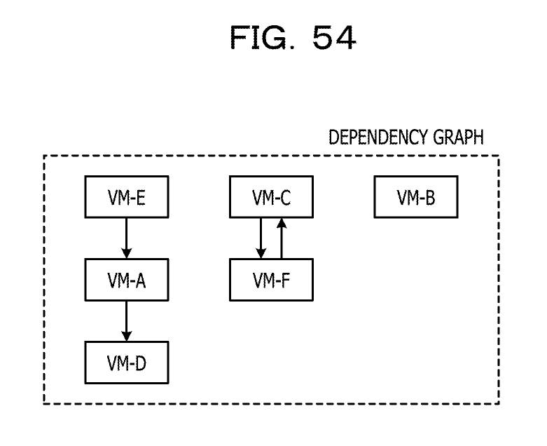

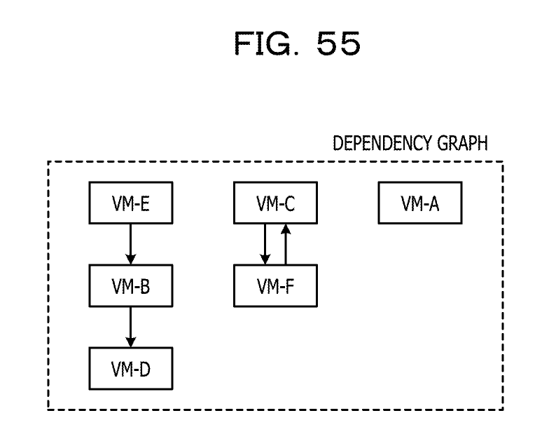

In particular, it is possible for the dependency virtual machine group specification unit 116 to create, in addition to the dependency graph depicted in FIG. 41, dependency graphs depicted in FIGS. 53 to 55 (four different dependency graphs) by the creation method of the partial dependency graph E and the partial dependency graph A. In particular, the dependency graph depicted in FIG. 53 is a dependency graph in the case where the VM-A has a dependency relationship to the VM-E and the VM-D has a dependency relationship to the VM-B. Further, the dependency graph depicted in FIG. 54 is a dependency graph in the case where the VM-A has a dependency relationship to the VM-E and the VM-D has a dependency relationship to the VM-A. Further, the dependency graph depicted in FIG. 55 is a dependency graph in the case where the VM-B has a dependency relationship to the VM-E and the VM-D has a dependency relationship to the VM-B.

Therefore, the dependency virtual machine group specification unit 116 selects one dependency graph from among the dependency graphs depicted in FIGS. 41 and 53 to 55, for example, by performing the processes at steps S81 to S84. Then, the dependency virtual machine group specification unit 116 creates, for example, dependency virtual machine information 136 and dependency virtual machine group information 137 corresponding to the selected dependency graph (S85 and S63). This makes it possible for the dependency virtual machine group specification unit 116 to execute the migration controlling process even in the case where there exist a plurality of combinations of virtual machines 3 specifiable as dependency virtual machined 31.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A migration controlling method executed by a computer comprising a processor and a storage, comprising:
reading state information indicating stats of a plurality of virtual machines and stats of a plurality of physical machines, the state information stored in the storage;
reading migration information corresponding to information of the plurality of virtual machines, information of a first physical machine of migration source of the virtual machines, and information of a second physical machine of migration destination of the virtual machines, the first and second physical machines included in the plurality of physical machines, the migration information stored in the storage;
instructing by the processor, migration of a first virtual machine to the second physical machine designated on the basis of the state information and migration information;
instructing by the processor, migration of a second virtual machine not instructed to migrate to the second physical machine to a third physical machine except of the second physical machine; and
updating by the processor, the state information on the basis of the state of the plurality of virtual machines and the plurality of physical machines after migration of the first and second virtual machines.

2. The migration controlling method according to claim 1, wherein
the state information includes information of a free capacity of a physical resource of each of the plurality of physical machines and information of a use capacity of a physical resource used for operation of each of the plurality of virtual machines.

3. The migration controlling method according to claim 2 further comprising
determining a virtual machine using a physical resource equal to or smaller than a free capacity of a physical resource of the second physical machine from among the plurality of virtual machines, as the first virtual machine migratable to the second physical machine.

4. The migration controlling method according to claim 2 further comprising
instructing the plurality of virtual machines to migrate in a descending order of the use amount of the physical resource.

5. The migration controlling method according to claim 2 further comprising
instructing the plurality of virtual machines to migrate in an ascending order of the use amount of the physical resource.

6. The migration controlling method according to claim 1 further comprising
stopping a migration process of a virtual machine when all of the plurality of virtual machines is instructed to migrate to the second physical machine.

7. The migration controlling method according to claim 1, further comprising:
instructing the first virtual machine being instructed to migrate to the second physical machine to migrate to the physical machine of the migration source when all of virtual machines capable of retracting into the second physical machine are instructed to retract; and
stopping the migration process of the virtual machine.

8. The migration controlling method according to claim 1, further comprising
instructing migration of the virtual machine is performed repetitively until all of the plurality of virtual machines are instructed to migrate to any of the plurality of physical machines.

9. The migration controlling method according to claim 1, further comprising:
specifying, before the instructing, a dependency virtual machine that is a virtual machine to be migrated previously in order to allow the plurality of virtual machines to be individually migrated to the physical machines of the respective migration destinations; and
specifying one or more dependency virtual machine groups each including two or more virtual machines between or among which a relationship of the dependency virtual machine and a virtual machine that is enabled to migrate to the physical machine of the migration destination by the previous migration of the dependency virtual machine is circulated,
wherein the instructing instructs one virtual machine that is retractable and is included in each of the one or more dependency virtual machine groups to retract into a physical machine other than the physical machine of the migration destination.

10. The migration controlling method according to claim 9, wherein
the two or more virtual machines that have a circulating relationship are two or more virtual machines that have a relationship that, from among the specified dependency virtual machines, each virtual machine included in the two or more virtual machines is the dependency virtual machine of a different virtual machine included in the two or more virtual machines and that the dependency virtual machine of each virtual machine included in the two or more virtual machines is a different virtual machine included in the two or more virtual machines.

11. The migration controlling method according to claim 9, wherein,
where there exist a plurality of combinations of virtual machines specifiable as the dependency virtual machines, the specifying specifies, as the dependency virtual machines, virtual machines corresponding to a combination that exhibits a minimum number of times by which the instructing is performed until all of virtual machines are instructed to migrate to the physical machine of the migration destination.

12. The migration controlling method according to claim 11, wherein,
where there exist the plurality of combinations that exhibit the minimum number of times by which the instructing is performed, the specifying specifies, as the dependency virtual machines, virtual machines corresponding to a combination that exhibits a minimum number of times by which a retraction instruction to a physical machine other than the physical machine of the migration destination is issued until all of virtual machines are instructed to migrate to the physical machine of the migration destination.

13. A migration controller comprising:
a storage; and
a processor configured to
read state information indicating stats of a plurality of virtual machines and stats of a plurality of physical machines, the state information stored in the storage;
read migration information corresponding to information of the plurality of virtual machines, information of a first physical machine of migration source of the virtual machines, and information of a second physical machine of migration destination of the virtual machines, the first and second physical machines included in the plurality of physical machines, the migration information stored in the storage;
instruct migration of a first virtual machine to the second physical machine designated on the basis of the state information and migration information;
instruct migration of a second virtual machine not instructed to migrate to the second physical machine to a third physical machine except of the second physical machine; and
update the state information on the basis of the state of the plurality of virtual machines and the plurality of physical machines after migration of the first and second virtual machines.
